(19) United States
(12) Patent Application Publication
(10) Pub. No.: US 2007/0222712 A1
(43) Pub. Date: Sep. 27, 2007

(54) Image Display Apparatus and Method of Driving the Same

(76) Inventors: Yutaka Chiaki, Miyazaki (JP); Shunji Ohta, Miyazaki (JP); Yuichiro Kimura, Miyazaki (JP)

Correspondence Address: STAAS & HALSEY LLP, SUITE 700, 1201 NEW YORK AVENUE, N.W., WASHINGTON, DC, 20005, US

(21) Appl. No.: 11/628,059

(22) PCT Filed: Aug. 23, 2005
(86) PCT No.: PCT/JP05/15282

§ 371 Date: Nov. 30, 2006

(51) Int. Cl. G09G 3/28

(52) U.S. Cl. 345/63

(57) ABSTRACT

An image display apparatus divides one field into plural weighted subfields and combines the plural subfields to perform a multi-gray-scale image display on a display panel. The image display apparatus includes a motion amount detecting circuit 50, a diffusion amount calculating circuit 52, and a diffusion circuit 53. The motion amount detecting circuit 50 detects a motion amount from a current field and a field before the current field based on an input image signal. The diffusion amount calculating circuit 52 calculates a diffusion amount to diffuse false contour noise to the surrounding, based on a gray scale of the input image signal and the detected motion amount. The diffusion circuit 53 performs a diffuse process in the calculated diffusion amount. With this arrangement, it is possible to improve the image quality of a moving-image display, by decreasing a false contour, without generating additional noise and without increasing the circuit scale.

### TECHNICAL FIELD

The present invention relates to an image display apparatus and a method of driving the same, and more particularly, to an image display apparatus that divides one field of a plasma display panel (PDP) or the like into plural weighted subfields, and performs a multi-gray-scale image display of these subfields on a display panel by combining these subfields. The invention also relates to a method of driving this image display apparatus.

### BACKGROUND ART

In recent years, along the increase in sizes of a display apparatus, a thin display apparatus has been required, and various kinds of thin display apparatuses are provided. For example, a gas-discharge panel such as a PDP, and a matrix panel such as a DMD (digital micromirror device), an EL (electro-luminescence) display element, a fluorescent character display tube, and a liquid-crystal display element are provided. Among these thin display apparatuses, the gas-discharge panel has been practically used for an HDTV (large-screen direct-view high-definition television) display device, because of its characteristics of self light-emission, satisfactory display quality, and fast response speed.

For example, the plasma display apparatus includes plural weighted subfields (SF, i.e., light-emitting blocks) configured by plural sustain pulses within each field (i.e., frame). The plasma display apparatus performs an image display by executing a multi-gray-scale image control of subfields by illuminating and non-illuminating these subfields. In the image display apparatus that performs this multi-gray-scale image display by controlling illumination and non-illumination of the subfields, false contour noise occurs in the contour or edge of a moving image. Therefore, provision of an image display apparatus that can decrease the false contour in a simple configuration, and a method of driving this image display apparatus has been required.

Conventionally, among the plasma display apparatus, the liquid-crystal display apparatus, and the EL display apparatus, there has been provided an image display apparatus (i.e., a multi-gray-scale image display apparatus) that divides one field into plural subfields at a predetermined luminance ratio (or weight), encodes each image display cell in a luminous state or a non-luminous state in a subfield unit of a predetermined weight, and executes a multi-gray-scale image control of the subfields to display an image. According to the image display apparatus that divides one field into plural weighted subfields and combines these subfields to perform a multi-gray-scale image display on a display panel, a person (a viewer) who watches a moving target on the screen of the image display apparatus recognizes a false contour of the object that moves faster than a certain speed, depending on a screen size of the display panel, or a number of pixels, or an image actually displayed on the screen.

As methods of decreasing this false contour, a dither method, a superposition method, and a path switch method have been proposed. However, these methods are not sufficiently satisfactory, and on the contrary, there are adverse effects. According to the dither method and the superposition method, hatched noise occurs. According to the path switch method, particle noise occurs due to error diffusion of a subpath.

Conventionally, as an image display apparatus that divides one field into plural weighted subfields and combines the plural subfields to perform a multi-gray-scale image display on a display panel, there has been proposed the apparatus that sets a sustain period of each subfield period to approximately the same length within one field period, thereby preventing the occurrence of false contour noise without generating a flicker. This image display apparatus expresses image data in N+1 gray scales, using luminance levels from 0 to N, on the display panel (for example, see a patent document 1).

Further, conventionally, as an image display apparatus that divides one field into plural weighted subfields and combines the plural subfields to perform a multi-gray-scale image display on a display panel, there has been also proposed the apparatus that obtains a possibility of the occurrence of false contour noise as noise amount, and performs, based on this noise amount, a diffusion process of decreasing the false contour noise in an area of an image where false contour noise is forecast to occur (for example, see a patent document 2).

Further, conventionally, as an image display apparatus that divides one field into plural weighted subfields and combines the plural subfields to perform a multi-gray-scale image display on a display panel, there has been also proposed the apparatus that applies a superposition method to only an area in which only one of plural subfields having the same luminance weight is illuminated and a slope of luminance between adjacent pixels is within a set range of values in a display image, in order to improve the image quality of a moving-image display by decreasing a false contour and by suppressing the occurrence of pattern noise (for example, see a patent document 3).

Patent document 1: Japanese Unexamined Patent Publication (Kokai) No. 10-031455

Patent document 2: Japanese Unexamined Patent Publication (Kokai) No. 11-231827

Patent document 3: Japanese Unexamined Patent Publication (Kokai) No. 2002-372948

### DISCLOSURE OF THE INVENTION

### Problem to be Solved by the Invention

As described above, the image display apparatus that divides one field into plural weighted subfields and combines the plural subfields to perform a multi-gray-scale image display on the display panel has the problem of a false contour. As methods of decreasing this false contour, a dither method, a superposition method, and a path switch method are known. However, according to the superposition method, a viewer recognizes hatched noise in a moving image, as the adverse effect of the superposition method. This hatched noise is recognized when the image is moving slowly, and is not easily recognized when the image is moving relatively faster. This is considered because when the image is moving fast, the eyeshot moves across plural images, thereby offsetting the hatched noise.

According to the above patent document 1, while a false contour can be prevented by switching a main path with a subpath, a moving image has a large moving area, and noise is recognized strongly due to the error diffusion in a subpath, regardless of the moving speed of the moving image. Further, because a changeover shock of a changeover between the subpath and the main path (i.e., particle noise of the error diffusion in the subpath relative to a smooth gray-scale expression of the main path) is large, this changeover shock give uncomfortable feeling to the viewer.

According to the patent document 2, while false contour noise is decreased in the area having a possibility of the occurrence of false-contour noise based on a result of a forecast carried out by a false-contour noise detecting device, the false-contour determining device performs a logical calculation of a pixel value between each pixel and a peripheral pixel of an input image that is divided into plural subfields, based on an output of a motion detector. This device performs a modulate process to decrease a false contour, by detecting a position of the occurrence of a false contour. However, it is known that a false contour occurs in a moving image and when a predetermined gray scale is displayed. Therefore, so long as a motion amount can be detected, the false-contour noise detecting device is not necessary, and this causes a redundant configuration.

According to the patent document 3, hatched noise due to the method of superposing specified gray scales of a moving image can be decreased. However, false contours are noticed at different levels among images that move at the same speed. Therefore, when a false contour of an image is noticeable and also when this false contour does not exceed a threshold value of determination of superposition, superposition is not performed and the false contour is recognized. On the other hand, when a false contour of an image is not easily noticeable and also when the false contour exceeds a threshold value of determination of superposition, superposition is performed and hatched noise is recognized. Intensity of this hatched noise cannot be controlled, and this is determined depending on an illumination pattern.

As explained above, according to the conventional methods of decreasing a false contour, a position at which a false contour occurs is detected, and this position is modulated. Therefore, a circuit scale increases, and cost increases. Further, according to the conventional methods, noise occurs as an adverse effect of decreasing a false contour.

The present invention has been made in the light of the above problems of the conventional technique of decreasing a false image. It is an object of the present invention to provide an image display apparatus that can improve image quality of a moving-image display by decreasing a false contour, without generating additional noise and without increasing a circuit scale, and a method of driving the image display apparatus.

### Means for Solving the Problems

According to a first aspect of the present invention, there is provided an image display apparatus that divides one field into plural weighted subfields and combines the plural subfields to perform a multi-gray-scale image display on a display panel, the image display apparatus including: a motion amount detecting circuit that detects a motion amount from a current field and a field before the current field based on an input image signal; a diffusion amount calculating circuit that calculates a diffusion amount to diffuse false contour noise to the surrounding, based on a gray scale of the input image signal and the detected motion amount; and a diffusion circuit that performs a diffuse process in a diffusion amount calculated by the diffusion amount calculating circuit.

According to a second aspect of the present invention, there is provided an image display apparatus that divides one field into plural weighted subfields and combines the plural subfields to perform a multi-gray-scale image display on a display panel, the image display apparatus including: a main path that generates a signal of a predetermined number of gray scales from an input image signal; a subpath that generates a signal of gray scales of which number is smaller than the number of gray scales in the main path; a path switch circuit that outputs one of a signal generated in the main path and a signal generated in the subpath by changing over between the signal generated in the main path and the signal generated in the subpath; a motion amount detecting circuit that detects an area which moves between a current field and a field before the current field from the input image signal, and that outputs a motion amount as an amount of the move; a level detecting circuit that detects a level amount of intensity of a false contour of a moving image when the false contour occurs in the main path; a subpath determining circuit that compares the detected motion amount and the detected level amount with predetermined set values, and determines a gray scale of a moving image area having high intensity of the occurrence of a false contour; a subpath switch that changes over the path switch circuit from an output of the main path to an output of the subpath, based on a result of a determination of the subpath determining circuit; a diffusion coefficient generating circuit that generates a diffusion coefficient which depends on a gray scale of the input image signal used to calculate a diffusion amount of false contour noise to be diffused to the surrounding; a diffusion amount calculating circuit that calculates a diffusion amount based on the motion amount and the diffusion coefficient; and a diffusion circuit that performs a diffuse process in a diffusion amount calculated by the diffusion amount calculating circuit, wherein the image display apparatus decreases a false contour by controlling the subpath switch and the diffusion amount.

According to a third aspect of the present invention, there is provided an image display apparatus that divides one field into plural weighted subfields and combines the plural subfields to perform a multi-gray-scale image display on a display panel, the image display apparatus including: a main path that generates a signal of a predetermined number of gray scales from an input image signal; a subpath that generates a signal of gray scales of which number is smaller than the number of gray scales in the main path; a diffusion process path that generates a signal obtained by performing a diffusion process to the input image signal; a path switch circuit that outputs one of a signal generated in the main path, a signal generated in the subpath, and a signal generated in the diffusion process path, by changing over between the signal generated in the main path, the signal generated in the subpath, and the signal generated in the diffusion process path; a motion amount detecting circuit that detects an area which moves between a current field and a field before the current field from the input image signal, and that outputs a motion amount as an amount of the move; a level detecting circuit that detects a level amount of intensity of a false contour of a moving image when the false contour occurs in the main path; a path changeover determining circuit that compares the detected motion amount and the detected level amount with predetermined set values, and determines a gray scale of a moving area having high intensity of the occurrence of a false contour; a path changeover circuit that changes over the path switch circuit to any one of an output of the main path, an output of the subpath, and an output of the diffusion process path, based on a result of a determination of the subpath determining circuit; a diffusion coefficient generating circuit that generates a diffusion coefficient which depends on a gray scale of the input image signal used to calculate a diffusion amount of false contour noise to be diffused to the surrounding; a diffusion amount calculating circuit that calculates a diffusion amount based on the motion amount and the diffusion coefficient; and a diffusion circuit that performs a diffuse process in a diffusion amount calculated by the diffusion amount calculating circuit, wherein the image display apparatus decreases a false contour by controlling the path changeover switch and the diffusion amount.

According to a fourth aspect of the present invention, there is provided a method of driving an image display apparatus that divides one field into plural weighted subfields and combines the plural subfields to perform a multi-gray-scale image display on a display panel, the method including: a motion amount detecting step of detecting a motion amount from a current field and a field before the current field based on an input image signal; a diffusion amount calculating step of calculating a diffusion amount to diffuse false contour noise to the surrounding, based on a gray scale of the input image signal and the detected motion amount; and a diffusion step of performing a diffuse process in the calculated diffusion amount.

According to a fifth aspect of the present invention, there is provided a method of driving an image display apparatus that divides one field into plural weighted subfields and combines the plural subfields to perform a multi-gray-scale image display on a display panel, the method including: a path switching step of outputting one of a signal generated by a main path that generates a signal of a predetermined number of gray scales from an input image signal, and a signal generated by a subpath that generates a signal of gray scales of which number is smaller than the number of gray scales in the main path, by switching between the signal generated in the main path and the signal generated in the subpath; a motion amount detecting step of detecting an area which moves between a current field and a field before the current field from the input image signal, and outputting a motion amount as an amount of the move; a level detecting step of detecting a level amount of intensity of a false contour of a moving image when the false contour occurs in the main path; a subpath determination step of comparing the detected motion amount and the detected level amount with predetermined set values, and determining a gray scale of a moving image area having high intensity of the occurrence of a false contour; a subpath switching step of switching the path switching step from an output of the main path to an output of the subpath based on a result of a determination at the subpath determination step; a diffusion coefficient generating step of generating a diffusion coefficient which depends on a gray scale of the input image signal used to calculate a diffusion amount of false contour noise to be diffused to the surrounding; a diffusion amount calculating step of calculating a diffusion amount based on the motion amount and the diffusion coefficient; and a diffusion step of performing a diffuse process in the calculated diffusion amount, wherein a false contour is decreased by controlling the subpath switch and the diffusion amount.

According to a sixth aspect of the present invention, there is provided a method of driving an image display apparatus that divides one field into plural weighted subfields and combines the plural subfields to perform a multi-gray-scale image display on a display panel, the method including: a path switching step of outputting one of a signal generated by a main path that generates a signal of a predetermined number of gray scales from an input image signal, a signal generated by a subpath that generates a signal of gray scales of which number is smaller than the number of gray scales in the main path, and a signal generated from a diffusion process path that generates a signal obtained by performing a diffusion process to the input image signal, by switching between the signal generated in the main path, the signal generated in the subpath, and the signal generated by the diffusion process path; a motion amount detecting step of detecting an area which moves between a current field and a field before the current field from the input image signal, and outputting a motion amount as an amount of the move; a level detecting step of detecting a level amount of intensity of a false contour of a moving image when the false contour occurs in the main path; a path changeover determination step of comparing the detected motion amount and the detected level amount with predetermined set values, and determining a gray scale of a moving image area having high intensity of the occurrence of a false contour; a path changeover step of changing over the path switching step from an output of the main path to an output of the subpath or an output of the diffusion process path based on a result of a determination at the pass changeover determination step; a diffusion coefficient generating step of generating a diffusion coefficient which depends on a gray scale of the input image signal used to calculate a diffusion amount of false contour noise to be diffused to the surrounding; a diffusion amount calculating step of calculating a diffusion amount based on the motion amount and the diffusion coefficient; and a diffusion step of performing a diffuse process in a diffusion amount calculated at the diffusion amount calculating step, wherein a false contour is decreased by controlling the path changeover step and the diffusion amount.

### Effect of the Invention

According to the present invention, it is possible to provide an image display apparatus that can improve image quality of a moving-image display by decreasing a false contour, without generating additional noise and without increasing a circuit scale, and a method of driving the image display apparatus.

### BRIEF DESCRIPTION OF THE DRAWINGS

FIG. 1 is a block diagram schematically showing one example of an image display apparatus to which the present invention is applied;

FIG. 2 is a block diagram showing one example of a multi-gray-scale image signal processing circuit of an image display apparatus according to a first embodiment of the present invention;

FIG. 3 is a block diagram showing one example of a path (a main path) of the multi-gray-scale image signal processing circuit shown in FIG. 2;

FIG. 4 is a block diagram showing one example of a motion amount detecting circuit in the multi-gray-scale image signal processing circuit shown in FIG. 2;

FIG. 5 shows one example of subfield conversion data stored in a subfield encoding circuit of the multi-gray-scale image signal processing circuit shown in FIG. 2;

FIG. 6 shows one example of a driving sequence of a drive control circuit in the image display apparatus according to the present invention;

FIG. 7 is a block diagram showing other example of a path (a main path) of a multi-gray-scale image signal processing circuit in the image display apparatus according to a second embodiment of the present invention;

FIG. 8 is a block diagram showing one example of a motion adaptation dither circuit in the path of the multi-gray-scale image signal processing circuit shown in FIG. 7;

FIG. 9A is an explanatory diagram of a dither calculation within one field performed by a dither amount calculating circuit in the motion adaptation dither circuit shown in FIG. 8;

FIG. 9B an explanatory diagram of a dither calculation within one field performed by a dither amount calculating circuit in the motion adaptation dither circuit shown in FIG. 8;

FIG. 10A is an explanatory diagram of a relationship between a gray scale and a dither coefficient in a method of driving an image display apparatus according to the present invention;

FIG. 10B is an explanatory diagram of a relationship between a gray scale and a dither coefficient in a method of driving an image display apparatus according to the present invention;

FIG. 10C is an explanatory diagram of a relationship between a gray scale and a dither coefficient in a method of driving an image display apparatus according to the present invention;

FIG. 11 is a block diagram showing other example of a motion adaptation dither circuit in the path of the multi-gray-scale image signal processing circuit shown in FIG. 7;

FIG. 12A is an explanatory diagram showing a relationship between a motion amount and a calculated motion amount of an input image signal in the image display apparatus according to the present invention;

FIG. 12B is an explanatory diagram showing a relationship between a motion amount and a calculated motion amount of an input image signal in the image display apparatus according to the present invention;

FIG. 12C is an explanatory diagram showing a relationship between a motion amount and a calculated motion amount of an input image signal in the image display apparatus according to the present invention;

FIG. 12D is an explanatory diagram showing a relationship between a motion amount and a calculated motion amount of an input image signal in the image display apparatus according to the present invention;

FIG. 13 is a block diagram showing one example of a multi-gray-scale image signal processing circuit of an image display apparatus according to a third embodiment of the present invention;

FIG. 14 is a block diagram showing one example of a subpath of the multi-gray-scale image signal processing circuit shown in FIG. 13;

FIG. 15 is a block diagram showing one example of a path switch circuit of the multi-gray-scale image signal processing circuit shown in FIG. 13;

FIG. 16 is a flowchart showing one example of a process of the path (the main path) in the multi-gray-scale image signal processing circuit of the image display apparatus according to the first embodiment of the present invention shown in FIG. 3;

FIG. 17 is a flowchart showing one example of a process of the path (the main path) in the multi-gray-scale image signal processing circuit of the image display apparatus according to the second embodiment of the present invention shown in FIG. 7;

FIG. 18 is a flowchart showing one example of a process in the multi-gray-scale image signal processing circuit of the image display apparatus according to the third embodiment of the present invention shown in FIG. 13;

FIG. 19 is a block diagram showing still other example of a path (a main path) in the multi-gray-scale image signal processing circuit of the image display apparatus according to a fourth embodiment of the present invention;

FIG. 20 is a block diagram showing one example of a multi-gray-scale image signal processing circuit of an image display apparatus according to a fifth embodiment of the present invention;

FIG. 21 is a block diagram showing one example of a main path of the multi-gray-scale image signal processing circuit shown in FIG. 20;

FIG. 22 is a block diagram showing one example of a path switch circuit of the multi-gray-scale image signal processing circuit shown in FIG. 20;

FIG. 23 is a block diagram showing one example of a diffusion path of the multi-gray-scale image signal processing circuit shown in FIG. 20;

FIG. 24 is a flowchart showing one example of a process in the multi-gray-scale image signal processing circuit of the image display apparatus according to the fifth embodiment of the present invention shown in FIG. 20; and

FIG. 25 is a block diagram showing a modification of a diffusion path of the multi-gray-scale image signal processing circuit shown in FIG. 20.

### EXPLANATION OF REFERENCE NUMERALS

1 Video signal input terminal

2 Synchronization signal input terminal

3 Multi-gray-scale image signal processing circuit

4 Field memory

5 Drive control circuit

6 Timing generating circuit

7 Display panel

10 Subpath (main path)

20, 21 Path (main path)

22 Diffusion path

30, 31 Path switch circuit

40 Subfield encoding circuit

50 Motion amount detecting circuit

51 Dither coefficient generating circuit

52, 58 Dither amount calculating circuit

53, 202 Dither circuit

54-1 to 54-n Dither gray scale setting circuit

55-1 to 55-n Dither coefficient setting circuit

56-1 to 56-n Dither gray scale comparing circuit

57 Dither coefficient selecting circuit

100 Distortion correcting circuit

101 Gain control circuit

102 Error diffusion circuit

103 Data matching circuit

200 Gain control circuit

201 Error diffusion circuit

203 Dither changeover circuit

204 Dither changeover determining circuit

205 Motion adaptation dither circuit

300 Level detecting circuit

301 Subpath determining circuit

302 Subpath switch

500 RGD matrix circuit

501 Edge detecting circuit

502 Moving area detecting circuit

503 Motion amount determining circuit

531 Dither amount adding circuit

532 Dither amount subtracting circuit

533 Horizontal counter

534 Vertical counter

535 Addition and subtraction selecting circuit

### BEST MODE FOR CARRYING OUT THE INVENTION

An image display apparatus and a method of driving the image display apparatus according to embodiments of the present invention are explained in detail below with reference to the accompanying drawings.

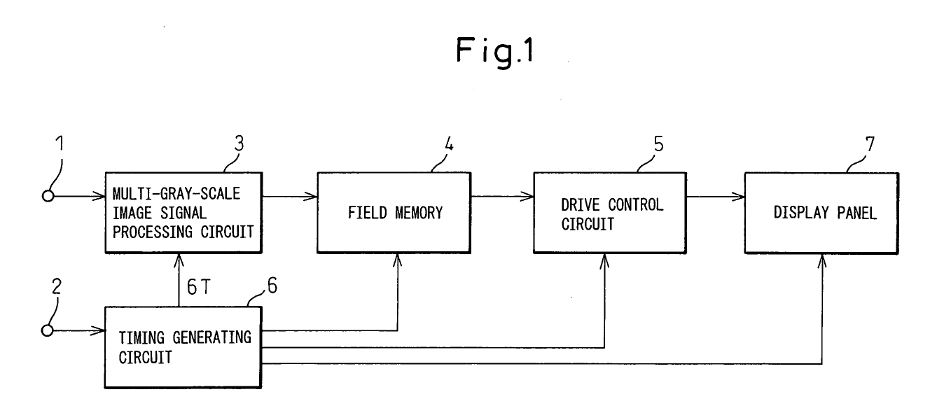

FIG. 1 is a block diagram schematically showing one example of an image display apparatus to which the present invention is applied. In FIG. 1, a reference numeral 1 denotes a digital video (image) signal input terminal, 2 denotes a synchronization signal input terminal for a horizontal synchronization signal, a vertical synchronization signal, a display period signal showing a display period, and a clock signal, 3 denotes a multi-gray-scale image signal processing circuit, 4 denotes a field memory, 5 denotes a drive control circuit, 6 denotes a timing generating circuit, and 7 denotes a display panel.

The field memory 4 can store image data of two fields. After storing data of one field, the field memory 4 sequentially reads data of the same subfields (SF) of the stored one field, during the next field period. The timing generating circuit 6 generates various kinds of timing signals such as a synchronization signal. The timing generating circuit 6 supplies a clock signal CLK, a horizontal synchronization signal Hsync, and a vertical synchronization signal Vsync to the multi-gray-scale image signal processing circuit 3 via a terminal 6T. The display panel 7 is a plasma display panel (PDP), for example, and includes various kinds of drivers (for example, an X driver, Y driver, and an address driver in a three-electrode alternate current drive-type PDP).

### EMBODIMENTS

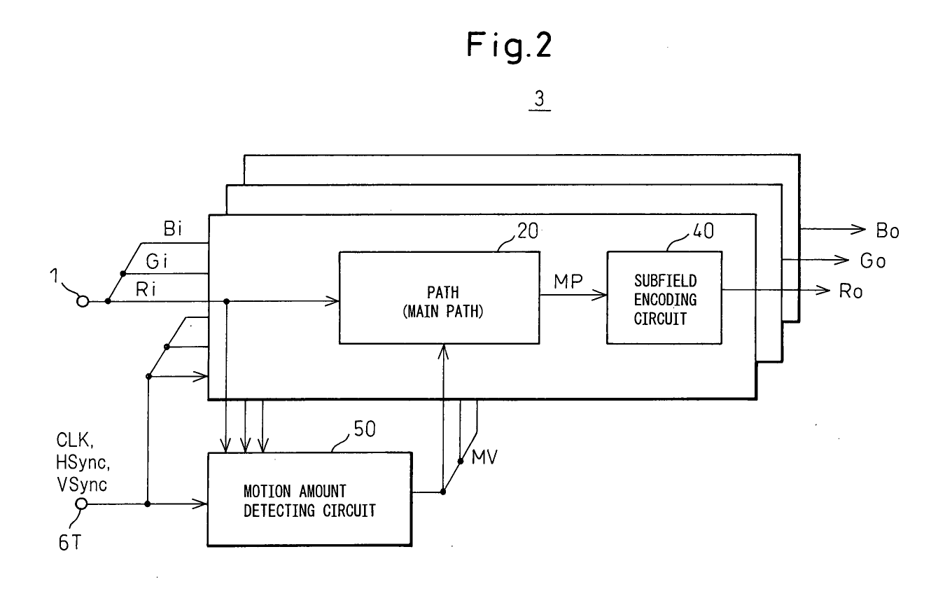

FIG. 2 is a block diagram showing one example of the multi-gray-scale image signal processing circuit 3 of the image display apparatus according to a first embodiment of the present invention.

The multi-gray-scale image signal processing circuit 3 receives video signals of three primary colors (a red color: Ri; a green color: Gi; and a blue color: Bi) supplied from the video signal input terminal 1, and the clock signal CLK, the horizontal synchronization signal Hsync, and the vertical synchronization signal Vsync from the timing generating circuit 6 via the terminal 6T. The multi-gray-scale image signal processing circuit 3 performs a multi-gray-scale image processing of each primary color, converts the multi-gray-scale image processed primary colors into illumination and non-illumination data signals of subfields (i.e., a red color: Ro; a green color Go; and a blue color: Bo), respectively, and outputs these signals to the field memory 4.

In other words, as shown in FIG. 2, the multi-gray-scale image signal processing circuit 3 according to the first embodiment includes a path (a main path) 20 and a subfield encoding circuit 40 that are provided for each primary color (for example, a red color: R), and a motion amount detecting circuit 50. The motion amount detecting circuit 50 receives the input video signals (i.e., the input image signals) of the three primary colors Ri, Gi, and Bi, and the timing signals (i.e., the synchronization signals) CLK, Hsync, and Vsync, and detects a motion amount MV from a current filed and a field before the current field in a pixel unit from the input video signal. The path 20 receives an input video signal of a corresponding primary color (for example, Ri), a timing signal, and the motion amount MV detected by the motion amount detecting circuit 50, and outputs the signal MV to the subfield encoding circuit 40. The Subfield encoding circuit 40 receives the signal MP from the path 20, and outputs a signal converted into illumination or non-illumination data of each subfield of a corresponding primary color (for example, Ro). The path 20 and the Subfield encoding circuit 40 are provided for each primary color, thereby obtaining the signals Ro, Go, and Bo that are SF encoded signals of the respective primary colors.

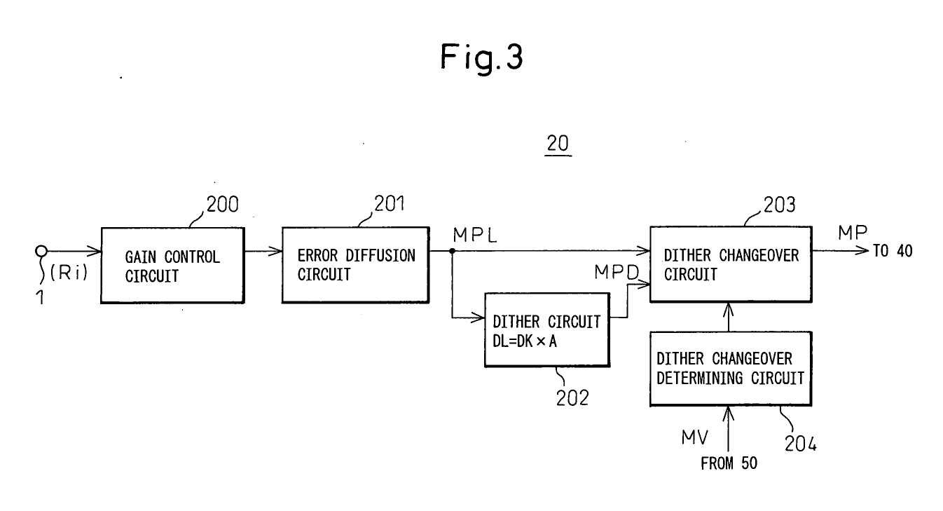

FIG. 3 is a block diagram showing one example of the path (i.e., the main path) 20 of the multi-gray-scale image signal processing circuit shown in FIG. 2. In the following description, a diffusion circuit is a dither circuit as an example. The configuration of the path 20 is similar for each of the signals of the three primary colors. In the following description, the red color (R) is mainly explained as an example.

As shown in FIG. 3, the path 20 includes a gain control circuit 200, an error diffusion circuit 201, a dither circuit 202, a dither changeover circuit 203, and a dither changeover determining circuit 204. The gain control circuit 200 receives the input video signal of each primary color (Ri), performs a gain control, and supplies the gain-controlled video signal to the error diffusion circuit 201. The error diffusion circuit 201 performs an error diffusion process to the gain-controlled video signal, and supplies an error-diffusion-processed signal MPL to both the dither circuit 202 and the dither changeover circuit 203.

The dither circuit 202 performs a conventionally-known dither process. The dither circuit 202 performs a dither process of a dither amount DL, and supplies a signal MPD as a result of the dithering, to the dither changeover circuit 203. The dither changeover determining circuit 204 checks whether the motion amount MV detected by the motion amount detecting circuit 50 is equal to or larger than a predetermined threshold value TD. When the motion amount MV is equal to or larger than the predetermined threshold value TD, the dither changeover determining circuit 204 outputs “1”, and when the motion amount MV is smaller than the predetermined threshold value TD, the dither changeover determining circuit 204 outputs “0”. When the dither changeover determining circuit 204 outputs “0”, the dither changeover circuit 203 selects the output signal ML of the error diffusion circuit 201. When the dither changeover determining circuit 204 outputs “1”, the dither changeover circuit 203 selects the output signal MPD of the dither circuit 202. The dither changeover circuit 203 supplies a selected output to the Subfield encoding circuit 40 as an output signal MP of the path 20.

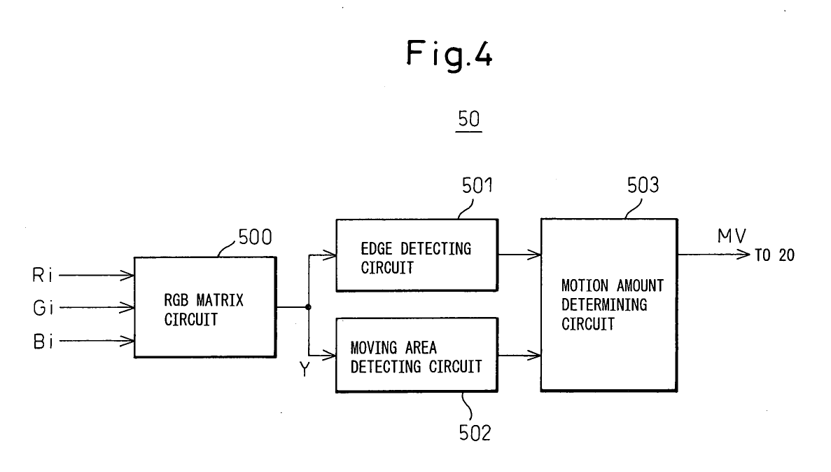

FIG. 4 is a block diagram showing one example of the motion amount detecting circuit 50 in the multi-gray-scale image signal processing circuit shown in FIG. 2.

As shown in FIG. 4, the motion amount detecting circuit 50 includes an RGB matrix circuit 500, an edge detecting circuit 501, a motion area detecting circuit 502, and a motion amount determining circuit 503. The RGB matrix circuit 500 generates a luminance signal Y from the video signals of the three primary colors Ri, Gi, and Bi supplied from the video signal input terminal 1, and supplies the luminance signal Y to the edge detecting circuit 501 and the motion area detecting circuit 502, respectively. The motion amount determining circuit 503 outputs a motion amount MV based on the output of the edge detecting circuit 501 and the output of the motion area detecting circuit 502.

FIG. 4 shows a state that the motion amount MV is determined based on the luminance signal Y, and the determined motion amount MV is output, using the RGB matrix circuit 500. Alternatively, the motion amount can be determined and output for each signal of the primary colors R, G, and B. In this case, the edge detecting circuit 501, the motion area detecting circuit 502, and the motion amount determining circuit 503 are different for each primary color signal.

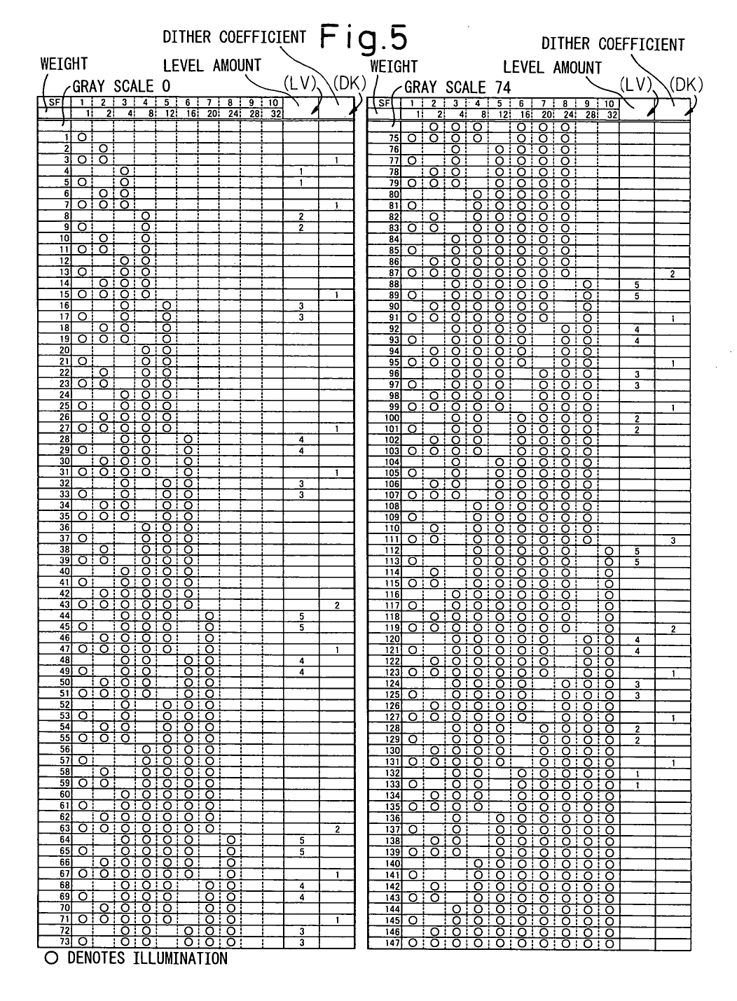

FIG. 5 shows one example of subfield conversion data stored in the subfield encoding circuit of the multi-gray-scale image signal processing circuit shown in FIG. 2. FIG. 5 shows one example of the content of an encoding conversion data table that is stored in the subfield encoding circuit 40, and a level amount, and a dither coefficient as a diffusion coefficient. A sign ◯ in FIG. 5 denotes illumination. Specifically, FIG. 5 illustrates that a gray scale 17 shows a state that subfields SF1, SF3, and SF5 are illuminated, and a gray scale 87 shows a state that subfields SF1 to SF8 are illuminated, for example. Further, FIG. 5 illustrates that the gray scale 17 shows a state that a level amount (LV) is set to 3, and the gray scale 87 shows a state that a dither coefficient (DK) is set to 2. A dither amount DL is obtained by multiplying the dither coefficient DK by a predetermined value A (i.e., DL=DK×A). The signal MP from the path 20 is converted into 147 gray scales, based on the encoding conversion data table shown in FIG. 5.

In FIG. 5, SF denotes an order of a subfield that is driven by the drive control circuit 5. SF1 denotes a subfield that is driven first. SF2 is a subfield that is driven at a second time, SF9 is a subfield that is driven at a ninth time, and SF10 is a subfield that is driven last. Each of the subfields SF1 to SF10 is weighted. Specifically, SF1, SF2, SF3, SF4, SF5, SF6, SF7, SF8, SF9, and SF10 are weighted with 1, 2, 4, 8, 12, 16, 20, 24, 28, and 32, respectively. Each weight of the subfields SF1 to SF10 corresponds to a ratio of an illumination amount between subfields. For example, when the number of gray scales of the input video signal (Ri) that is supplied to the gain control circuit 200 of the path 20 is 511 as a maximum with nine bits, the gain control circuit 200 performs a gain control of multiplying the gain by 147/511 times.

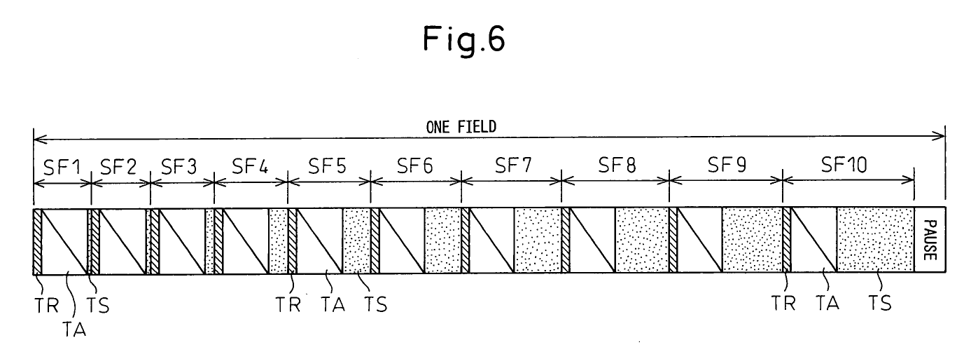

FIG. 6 shows one example of a driving sequence of the drive control circuit 5 in the image display apparatus according to the present invention.

As shown in FIG. 6, in this driving sequence, one field is divided into ten subfields including SF1 to SF10, and a display is performed by combining subfields that are illuminated for each display cell. Each of the subfields SF1 to SF10 includes a reset period TR during which all display cells are initialized, an address period TA during which all display cells are set to a state corresponding to an image to be displayed, and a sustain period (a sustain discharge period) TS during which each display cell is illuminated corresponding to a set state. The sustain period (a number of sustain pulses) of each of the subfields SF1 to SF10 corresponds to a ratio of the amount of illumination (a weight) between subfields. The sustain period is determined corresponding to the above weights of SF1: SF2: SF3: SF4: SF5: SF6: SF7: SF8: SF9: SF10=1: 2: 4: 8: 12: 16: 20: 24: 28: 32. The timing generating circuit 6 generates the reset period TR, the address period TA, and the sustain period TS, in each of the subfields SF1 to SF10.

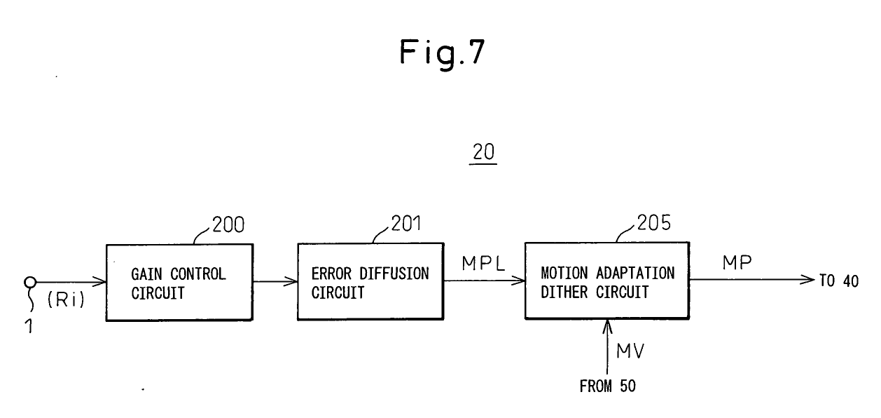

FIG. 7 is a block diagram showing other example of the path (the main path) 20 of the multi-gray-scale image signal processing circuit in the image display apparatus according to a second embodiment of the present invention.

As is clear from a comparison between FIG. 7 and FIG. 3, the path 20 of the multi-gray-scale image signal processing circuit 3 according to the second embodiment has a motion adaptation dither circuit 205, in place of the dither circuit 202, the dither changeover circuit 203, and the dither changeover determining circuit 204 according to the first embodiment explained with reference to FIG. 3. The gain control circuit 200 and the error diffusion circuit 201 are similar to those explained above, and their explanations are omitted.

The motion adaptation dither circuit 205 changes a dither amount corresponding to the motion amount MV as an output of the motion amount detecting circuit 50, and outputs the signal MP to the field memory 40.

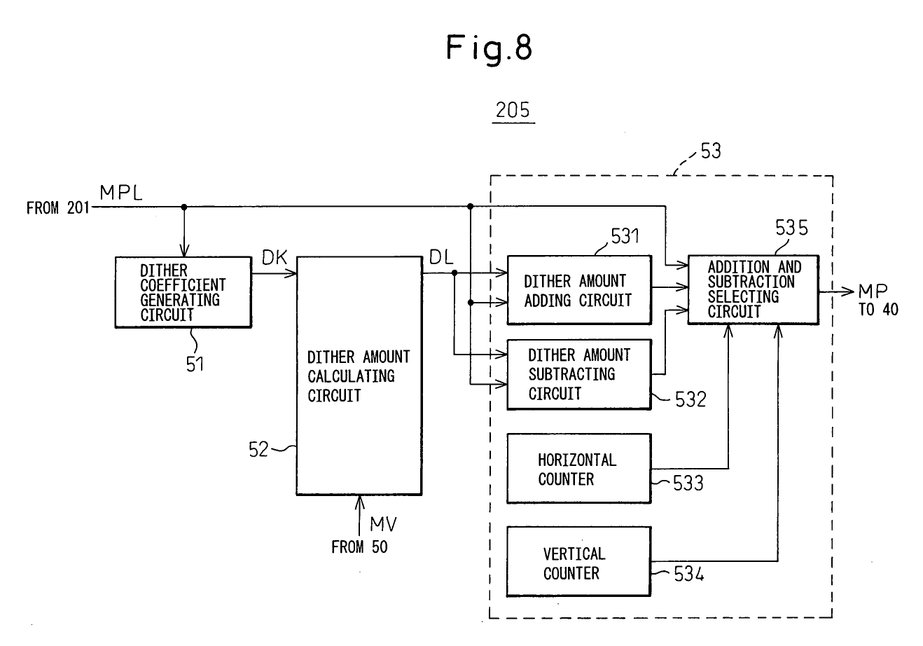

FIG. 8 is a block diagram showing one example of the motion adaptation dither circuit 205 in the path 20 of the multi-gray-scale image signal processing circuit shown in FIG. 7.

As shown in FIG. 8, the motion adaptation dither circuit 205 includes a dither coefficient generating circuit 51, a dither amount calculating circuit 52, and a dither circuit 53. The dither circuit 53 includes a dither amount adding circuit 531, a dither amount subtracting circuit 532, a horizontal counter 533, a vertical counter 534, and a subtraction selecting circuit 535. An output signal (a video signal) MPL of the error diffusion circuit 201 is supplied to the dither coefficient generating circuit 51, the dither amount adding circuit 531, the dither amount subtracting circuit 532, and the subtraction selecting circuit 535.

The dither coefficient generating circuit 51 outputs a dither coefficient DK as a modulation amount, to the dither amount calculating circuit 52, at a rate of intensity at which a dither for diffusion is to be applied. In this case, a predetermined amount of modulation can be output to a gray scale, as shown in FIG. 5. The dither amount calculating circuit 52 calculates a dither amount DL as a diffusion amount, based on the motion amount MV which is output from the motion amount detecting circuit 50 and the dither coefficient DK, and outputs the calculated dither amount DL to the dither amount adding circuit 531 and the dither amount subtracting circuit 532. The dither amount calculating circuit 52 calculates the dither amount DL as DL=MV×DK, and outputs the dither amount DL to the dither circuit 53.

The dither amount adding circuit 531 adds the dither amount DL calculated for the signal MPL by the dither amount calculating circuit 52. The dither amount subtracting circuit 532 subtracts the dither amount DL that is calculated for the signal MPL by the dither amount calculating circuit 52. The addition and subtraction selecting circuit 535 selects one of the output of the dither amount adding circuit 531, the output of the dither amount subtracting circuit, and the output signal MPL of the error diffusion circuit 201, following the outputs of the horizontal counter 533 and the vertical counter 534, and outputs the signal MP to the subfield encoding circuit 40.

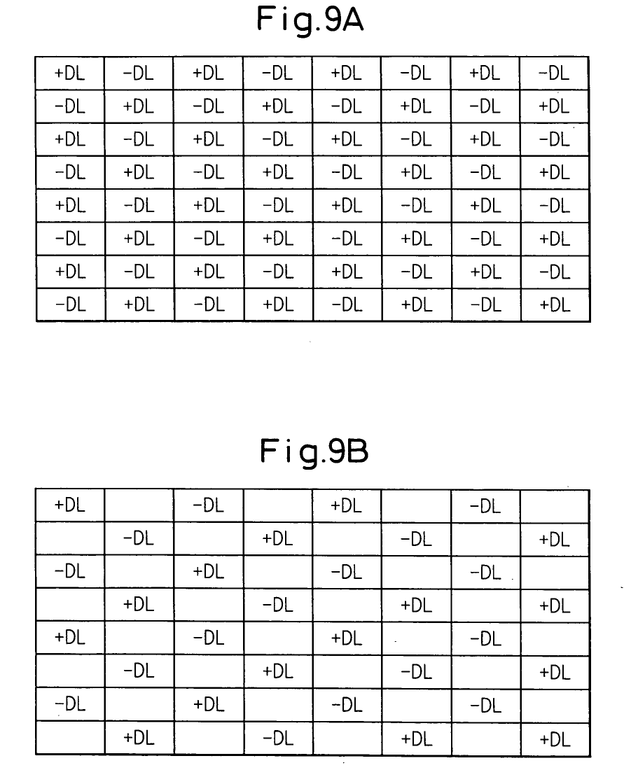

FIG. 9A and FIG. 9B are explanatory diagrams of a dither calculation within one field performed by the dither circuit 202 shown in FIG. 3 or by the dither amount calculating circuit 52 in the motion adaptation dither circuit 205 shown in FIG. 8. FIG. 9A and FIG. 9B show a result of dither calculation, respectively. In FIG. 9A, +DL and −DL repeated in a horizontal direction, and +DL and −DL are also repeated in a vertical direction. In FIG. 9B, four pixels including two times two pixels are used as one block, and +DL and −DL are changed over based on a predetermined rule that one +DL and one −DL are included in one block. The size of one block is not limited to the four pixels of two times two, and can be much larger than this size. It is sufficient that a sum of +DL and −DL becomes zero.

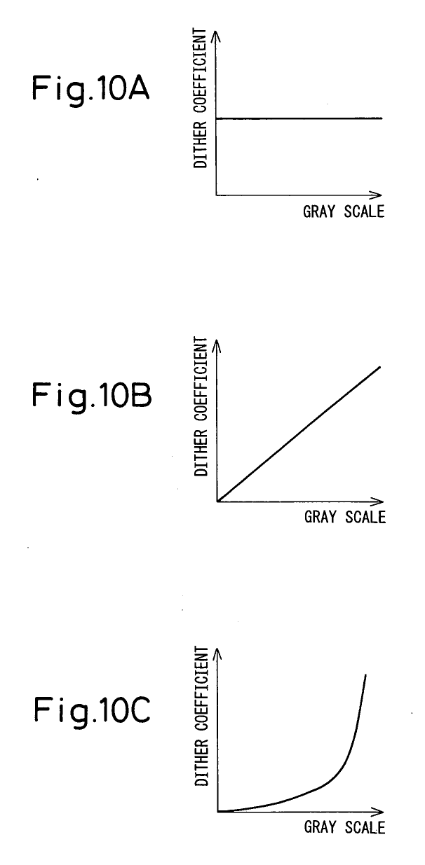

FIG. 10A to FIG. 10C are explanatory diagrams of a relationship between a gray scale and a dither coefficient in a method of driving the image display apparatus according to the present invention. FIG. 10A shows a state that the dither coefficient DK is fixed to the gray scale. FIG. 10B shows a state that the dither coefficient DK is proportional to the gray scale. FIG. 10C shows a state that the dither coefficient DK increases logarithmically with the gray scale.

When the dither coefficient DK is fixed to the gray scale as shown in FIG. 10A, a circuit scale can be minimized.

A human eye finds it difficult to recognize a difference between luminances when the luminances become higher. For example, the human eye can recognize a difference between the luminance of the gray scale 3 and the luminance of the gray scale 4. However, the human eye cannot recognize a difference between the luminance of the gray scale 3 and the luminance of the gray scale 141. As shown in FIG. 10C, the dither coefficient DK increases logarithmically with the gray scale. This takes into consideration that, according to the Weber-Fechner law, the sense of the human eye to luminance is logarithmically proportional to luminance. This logarithmic expression is most suitable to express the sense of the human eye to luminance. In this case, the dither coefficient generating circuit 51 is configured by a read-only memory (ROM) or the like. As shown in FIG. 10B, the relationship that the dither coefficient DK is proportional to a gray scale expresses an intermediate state between FIG. 10A and FIG. 10C.

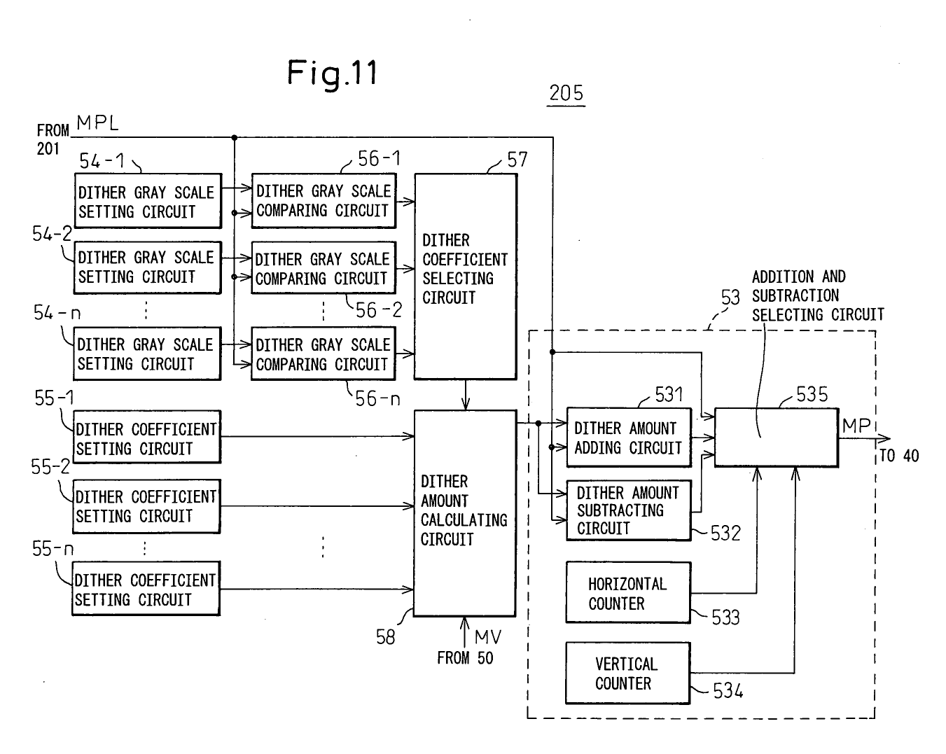

FIG. 11 is a block diagram showing other example of the motion adaptation dither circuit 205 in the path 20 of the multi-gray-scale image signal processing circuit shown in FIG. 7. In FIG. 11, the motion adaptation dither circuit 205 is also a gray-scale adaptation dither circuit.

As shown in FIG. 11, the motion adaptation dither circuit 205 includes the dither circuit 53, n dither gray-scale setting circuits 54-1 to 54-n, n dither coefficient setting circuits 55-1 to 55-n, n dither gray-scale comparing circuits 56-1 to 56-n, a dither coefficient selecting circuit 57, and a dither amount calculating circuit 58. The configuration of the dither circuit 53 is similar to that of the diffusion circuit 53 explained with reference to FIG. 8, and an explanation of this circuit is omitted.

The dither gray-scale setting circuit 54-1 sets a first gray scale to which a dither is to be applied, the dither gray-scale setting circuit 54-2 sets a second gray scale to which a dither is to be applied, and the dither gray-scale setting circuit 54-n sets an n-th gray scale to which a dither is to be applied. The dither coefficient setting circuit 55-1 sets a dither coefficient in a first gray scale, the dither coefficient setting circuit 55-2 sets a dither coefficient in a second gray scale, and the dither coefficient setting circuit 55-n sets a dither coefficient in the n-th gray scale.

Specifically, in the subfield conversion data shown in FIG. 5, the dither gray-scale setting circuit 54-1 sets the gray scale 3, and the dither coefficient setting circuit 55-1 sets a dither coefficient “1”. The dither gray-scale setting circuit 54-6 sets the gray scale 43, and the dither coefficient setting circuit 55-6 sets a dither coefficient “2”. The dither gray-scale setting circuit 54-15 sets the gray scale 111, and the dither coefficient setting circuit 55-15 sets a dither coefficient “3”. In the subfield conversion data shown in FIG. 5, the number of gray scales to which dithering is to be applied (i.e., the gray scales to which the dither coefficient “1”, “2”, or “3” is described) is 19 (i.e., n is 19). Therefore, 19 dither gray-scale setting circuits 54-1 to 54-19, and 19 dither coefficient setting circuits 55-1 to 55-19, and 19 dither gray-scale comparing circuits 56-1 to 56-19 are necessary.

A gray scale to which dithering is to be applied is the gray scale of which false contour is recognized easily. The dither coefficient expresses a ratio of intensity of dithering which is to be applied to the gray scale that requires the application of dithering. The dither coefficient is not limited to “1”, “2”, and “3”. A gray scale to which dithering is applied can change variously depending on subfield conversion data (i.e., drive sequence) to be applied.

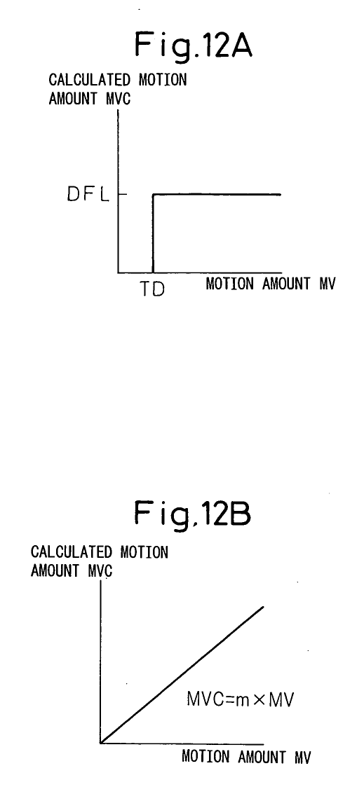

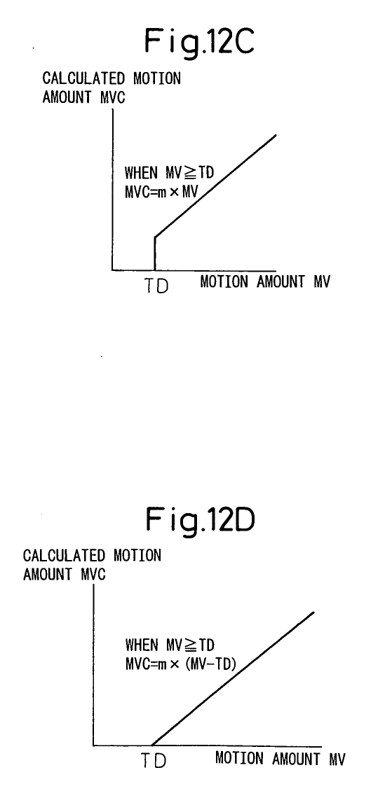

The dither gray-scale comparing circuits 56-1 to 56-n compare the corresponding dither gray-scale setting circuits 54-1 to 54-n with the output signal of the error diffusion circuit 201 (i.e., the input signal of the motion adaptation dither circuit 205) MPL. When the corresponding dither gray-scale setting circuits 54-1 to 54-n coincide with the output signal MPL of the error diffusion circuit 201, the dither gray-scale comparing circuits 56-1 to 56-n output “1”, and when the corresponding dither gray-scale setting circuits 54-1 to 54-n do not coincide with the output signal MPL of the error diffusion circuit 201, the dither gray-scale comparing circuits 56-1 to 56-n output “0”. The dither coefficient selecting circuit 57 outputs a signal corresponding to the dither gray-scale comparing circuits 56-1 to 56-n that output “1”. The dither amount calculating circuit 58 calculates the dither amount DL, by using the dither coefficients that are set to the dither coefficient setting circuits 55-1 to 55-n corresponding to the dither gray-scale comparing circuits 56-1 to 56-n that output “1”. The dither amount calculating circuit 58 can calculate the dither amount DL, by using any one of the methods shown in FIG. 12A to FIG. 12D. The dither amount calculating circuit 58 calculates the dither amount DL based on DL=MVC×DK, and outputs the calculated dither amount DL to the dither circuit 53. In other words, in calculating the dither amount DL, the dither amount calculating circuit 58 once converts the motion amount MV into a calculated motion amount MVC for practical application, and obtains the dither amount by using the calculated motion amount MVC.

FIG. 12A to FIG. 12D are explanatory diagrams showing a relationship between the motion amount MV and the calculated motion amount MVC of an input image signal in the image display apparatus according to the present invention.

FIG. 12A shows a first method of calculating the calculated motion amount MVC relative to the motion amount MV. When the motion amount MV is smaller than a predetermined threshold value TD, the calculated motion amount MVC is set to zero. When the motion amount MV is equal to or larger than the predetermined threshold value TD, the calculated motion amount MVC is fixed to a predetermined value DFL. FIG. 12B shows a second method of calculating the calculated motion amount MVC relative to the motion amount MV. The calculated motion amount MVC is proportional to the motion MV.

FIG. 12C shows a third method of calculating the calculated motion amount MVC relative to the motion amount MV. When the motion amount MV is smaller than the predetermined threshold value TD, the calculated motion amount MVC is set to zero. When the motion amount MV is equal to or larger than the predetermined threshold value TD, the calculated motion amount MVC is set proportional to the motion amount MV. FIG. 12D shows a fourth method of calculating the calculated motion amount MVC relative to the motion amount MV. When the motion amount MV is smaller than the predetermined threshold value TD, the calculated motion amount MVC is set to zero. When the motion amount MV is equal to or larger than the predetermined threshold value TD, the calculated motion amount MVC is set proportion to (MV−TD).

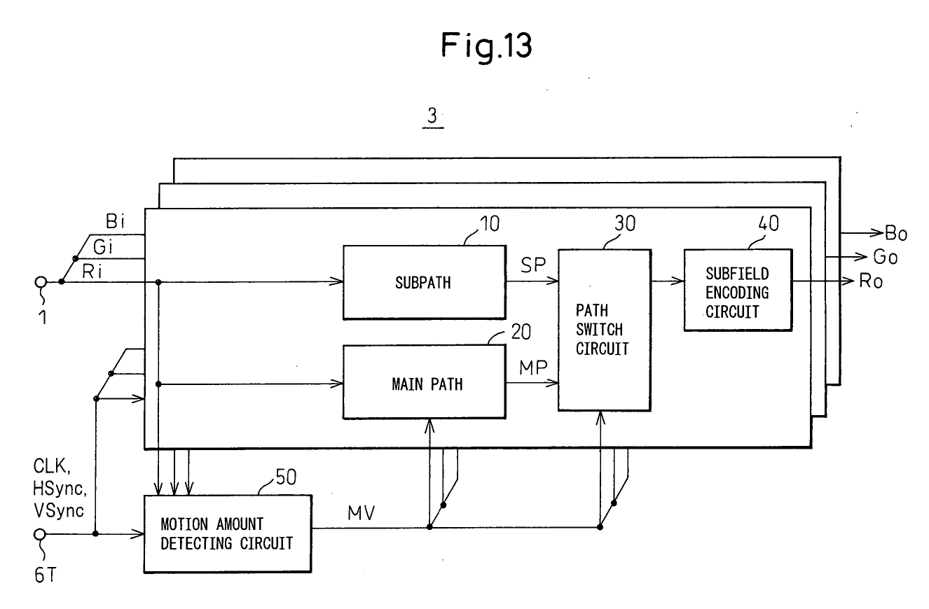

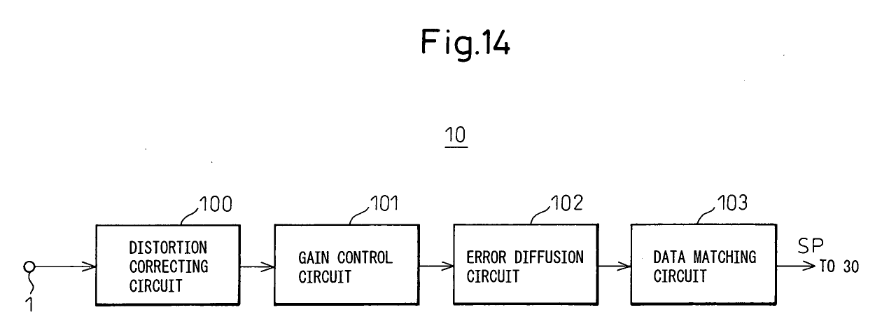

FIG. 13 is a block diagram showing one example of the multi-gray-scale image signal processing circuit 3 of an image display apparatus according to a third embodiment of the present invention. In FIG. 13, a reference numeral 10 denotes a subpath, the reference numeral 20 denotes the main path, 30 denotes a bath switch circuit, 40 denotes the subfield encoding circuit, and 50 denotes the motion amount detecting circuit. In other words, the third embodiment is an application of the path changeover method of the present invention to an image display apparatus.

As is clear from a comparison between FIG. 13 and FIG. 2 explained above, the multi-gray-scale image signal processing circuit 3 according to the third embodiment includes the subpath 10 and the main path 20 for each primary color. The path switch circuit 30 selects one of the output of the subpath 10 and the output of the main path 20, and supplies the selected output to the subfield encoding circuit 40. The subpath 10 is used to display an input image signal at a predetermined gray-scale level (for example, a gray-scale level smaller than the gray-scale level of the input image signal). The main path 20 can display the input image signal at an actual display gray-scale level. The path switch circuit 30 selects one of an output signal of the subpath 10 and an output signal of the main path 20 following the motion amount MV detected by the motion amount detecting circuit 50, and outputs the selected output signal to the subfield encoding circuit 40.

FIG. 14 is a block diagram showing one example of the subpath 10 of the multi-gray-scale image signal processing circuit shown in FIG. 13. The subpath circuit 10 expresses a video by using an illumination pattern that does not generate a false contour. In the case of the subfield conversion data shown in FIG. 5, eleven gray scales including the gray scales 0, 1, 3, 7, 15, 27, 43, 63, 87, 111, and 147 are used, and gray scales between these gray scales can be expressed by executing error diffusion.

As shown in FIG. 14, the subpath 10 includes a distortion correcting circuit 100, a gain control circuit 101, an error diffusion circuit 102, and a data matching circuit 103. The distortion correcting circuit 100 corrects a gray scale after the error diffusion by using an inverse function of the display characteristic after the error diffusion, thereby obtaining a linear display characteristic in total, because the number of gray scales that the subpath 10 can express does not increase proportionally to the luminance amount. The gain control circuit 101 multiplies a predetermined gain coefficient to the input image signal to enable the latter-stage error diffusion circuit 102 to perform an error diffusion process in the whole area of the input image signal. The gain control circuit 101 can be configured by a general multiplier, or a ROM or a RAM (random-access memory).

The error diffusion circuit 102 performs error diffusion to the image signal obtained via the gain control circuit 101, thereby artificially generating an intermediate gray scale to increase the number of gray scales. The data matching circuit 103 is provided to match the luminance level in the subpath 10 with the luminance level in the main path 20.

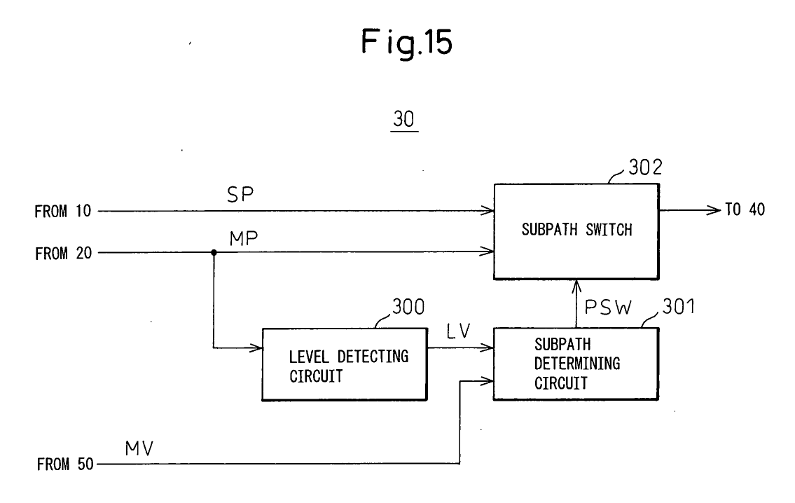

FIG. 15 is a block diagram showing one example of the path switch circuit 30 of the multi-gray-scale image signal processing circuit shown in FIG. 13.

As shown in FIG. 15, the path switch circuit 30 includes a level detecting circuit 300, a subpath determining circuit 301, and a subpath switch 302. The level detecting circuit 300 detects a gray scale at which a false contour occurs easily, in each pixel, and outputs occurrence intensity (i.e., a level amount) LV when the false contour occurs. The subpath determining circuit 301 outputs a subpath determination signal PSW, based on the output LV of the level detecting circuit 300 and the output (the motion amount) MV of the motion amount detecting circuit 50. The subpath switch 302 selects an output, according to the subpath determination signal PSW that is input from the subpath determining circuit 301. For example, when the subpath determination signal PSW is “1”, the subpath switch 302 selects the output SP of the subpath 10. When the subpath determination signal PSW is “0”, the subpath switch 302 selects the output MP of the main path 20. The subpath switch 302 outputs the selected output signal to the subfield encoding circuit 40.

The subpath determining circuit 301 outputs the subpath determination signal PSW “1”, when the motion amount MV is equal to or larger than a predetermined value TMP, and also when the level amount LV is equal to or larger than a predetermined value TLP. The subpath determining circuit 301 outputs the subpath determination signal PSW “0”, when the motion amount MV is smaller than the predetermined value TMP, or when the level amount LV is smaller than the predetermined value TLP. The value TMP and the value TLP are different depending on a screen size of the display panel 7 or the number of pixels of the display panel 7. Values that are determined based on a rule of thumb are used. Specifically, in the subfield conversion table shown in FIG. 5, values “0” to “5” are determined as the level amount LV, for each gray scale, for example. The values “0” to “5” of the level amount LV express intensity of a false contour when the false contour is recognized. The value “5” is set to a gray scale at which the recognized false contour is the strongest.

The intensity of the occurrence of a false contour is explained next. When gray scales are different from a predetermined gray scale between adjacent pixels of a certain video signal in a moving image, a person (i.e., a person who watches the screen of the image display apparatus) recognizes a false contour. The predetermined gray scale refers to a gray scale of which level amount increases from the level amount of a preceding fray scale (i.e., a carry). For example, in the subfield conversion data shown in FIG. 5, the predetermined gray scales are the gray scales 4, 8, 16, 28, 44, 64, 88, and 112. These gray scales are first carry gray scales, and the viewer strongly recognizes a false contour in these gray scales. Further, the gray scales 32, 48, 68, 92, and 120 are second carry gray scales. While the viewer recognizes a false contour in these gray scales, the false contour is not so strong as that of the first gray scale.

As described above, in FIG. 5, the level amount LV is expressed in five stages of intensity of the occurrence of a false contour. The level amounts LV of the gray scales 44, 64, 88, and 112 are “5”, respectively, and the level amounts LV of the gray scales 45, 65, 89, and 113 that are one gray scale above the gray scales 44, 64, 88, and 112, respectively are also “5”. In the actual video signal, when the gray scale is carried between the adjacent pixels, the carried gray scale is not necessary the above gray scale 44, 64, 88, or 112. Therefore, the level amount LV of the gray scale one above is also set to “5”.

The gray scales of the level amount LV “1” and above are carry gray scales of the subfield in the illumination pattern. The level amounts LV “4”, “3”, “2”, and “1” in continuous gray scales are at the same level amount. A position where a gray scale is carried between adjacent pixels can be also detected.

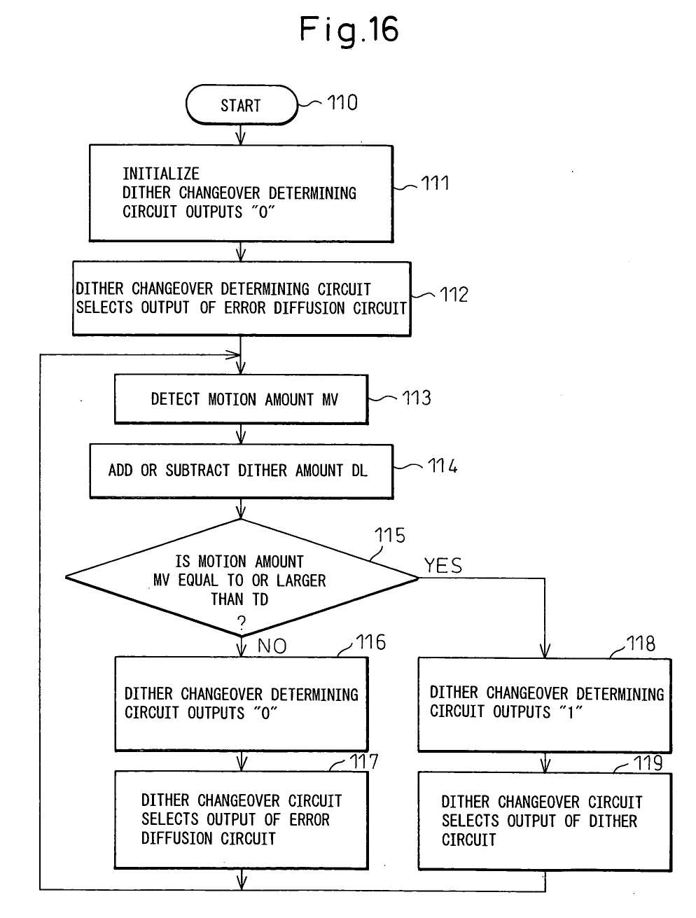

FIG. 16 is a flowchart showing one example of a process of the path (the main path) 20 in the multi-gray-scale image signal processing circuit of the image display apparatus according to the first embodiment of the present invention shown in FIG. 3. This flowchart explains the processes performed by the dither changeover circuit 203 and the dither changeover determining circuit 204.

When the process starts at step 110, the process is initialized at step 111, and the dither changeover determining circuit 204 outputs “0”. At step 112, the dither changeover circuit 203 selects the output signal MPL of the error diffusion circuit 201. At step 113, the dither changeover circuit 203 detects the motion amount MV. At step 114, the dither changeover circuit 203 adds or subtracts the dither amount DL. The dither coefficient DK to be used can be any one of those explained with reference to FIG. 10A to FIG. 10C, or the dither coefficient shown in FIG. 5.

At step 115, the dither changeover circuit 203 compares the motion amount MV with the predetermined threshold value (the determination threshold value) TD. When it is determined at step 115 that the motion amount MV is smaller than the determination threshold value TD, the dither changeover circuit 203 outputs “0” at step 116. At step 117, the dither changeover circuit 203 selects the output signal MPL of the error diffusion circuit 201, and the process returns to step 113. On other hand, when it is determined at step 115 that the motion amount MV is equal to or larger than the determination threshold value TD, the dither changeover circuit 203 outputs “1” at step 118. At step 119, the dither changeover circuit 203 selects the output signal MPD of the dither circuit 202, and the process returns to step 113. The above process is performed for each pixel or for each predetermined area, or for each primary color signal. The output signal MPL of the error diffusion circuit 201 or the output signal MPD of the dither circuit 202 selected by the dither changeover circuit 203 is supplied to the subfield encoding circuit 40 as the output signal MP of the path (the main path) 20.

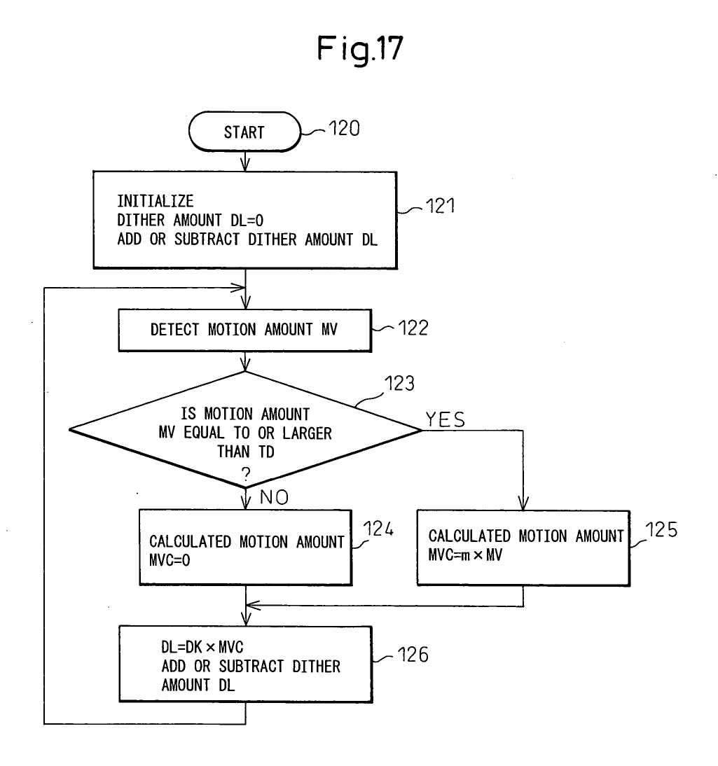

FIG. 17 is a flowchart showing one example of a process of the path (the main path) in the multi-gray-scale image signal processing circuit of the image display apparatus according to the second embodiment of the present invention shown in FIG. 7. FIG. 17 explains the process performed by the motion adaptation dither circuit 205. The relationship between the motion amount MV and the calculated motion amount MVC shown in FIG. 12C is used in this process. The dither coefficient DK to be used can be any one of those explained with reference to FIG. 10A to FIG. 10C, or the dither coefficient shown in FIG. 5.

When the process starts at step 120, the process is initialized at step 121, and the motion adaptation dither circuit 205 performs addition or subtraction of the dither amount 0, using the dither amount DL=0. In other words, at step 121, the motion adaptation dither circuit 205 does not perform addition or subtraction of the dither amount. At step 122, the motion adaptation dither circuit 205 detects the motion amount MV, and compares the motion amount MV with the determination threshold value TD at step 123.

When it is determined at step 123 that the motion amount MV is smaller than the determination threshold value TD, the motion adaptation dither circuit 205 sets the calculated motion amount MVC=0 at step 124, and the process proceeds to step 126. On the other hand, when it is determined at step 123 that the motion amount MV is equal to or larger the determination threshold value TD, the motion adaptation dither circuit 205 calculates the calculated motion amount MVC=mxMV at step 125, and the process proceeds to step 126. In this case, m is a proportional coefficient of the motion amount MV and the calculated motion amount MVC.

At step 126, the motion adaptation dither circuit 205 calculates the dither amount DL=DK×MVC, and adds or subtracts the dither amount DL. The output signal MP of the motion adaptation dither circuit 205 is supplied to the subfield encoding circuit 40 as the output signal MP of the path (the main path) 20.

In the flowchart shown in FIG. 17, when the relationship between the motion amount MV and the calculated motion amount MVC is the relationship shown in FIG. 12D, the calculated motion amount MVC at step 125 is obtained as MVC=m×(MV−TD).

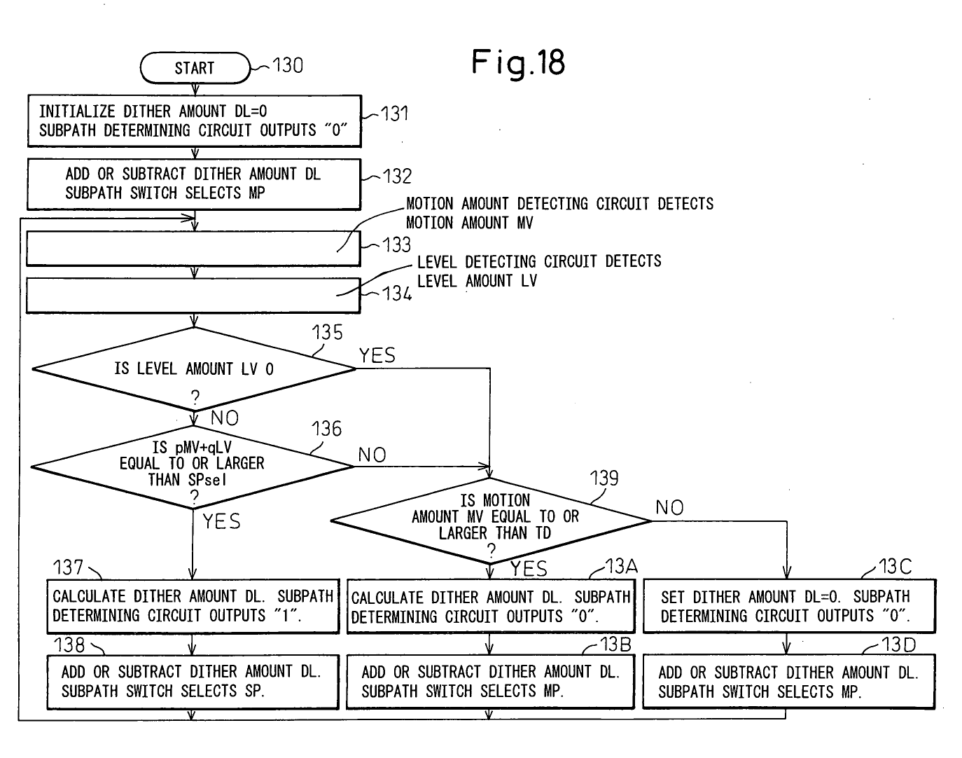

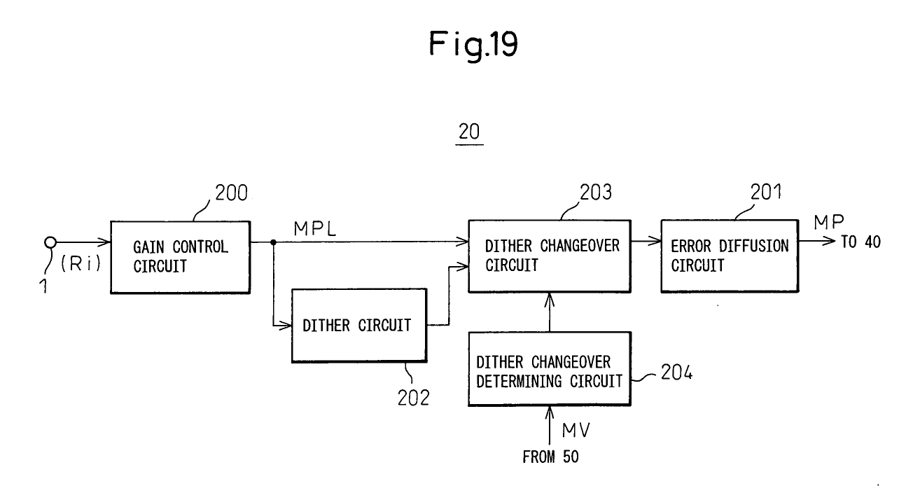

FIG. 18 is a flowchart showing one example of a process in the multi-gray-scale image signal processing circuit of the image display apparatus according to the third embodiment of the present invention shown in FIG. 13. This flowchart explains the process performed in the main path 20. The dither coefficient DK to be used can be any one of those explained with reference to FIG. 10A to FIG. 10C, or the dither coefficient shown in FIG. 5. The relationship between the motion amount MV and the calculated motion amount MVC to be applied in this process can be any one of the relationships shown in FIG. 12A to FIG. 12D.

When the process starts at step 130, the process is initialized at step 131, and the dither amount calculating circuit 58 (see FIG. 11) sets the dither amount DL=0, and sets the output signal of the subpath determining circuit 301 (i.e., the path determination signal) PSW to “0”. Next, the dither amount calculating circuit 58 adds or subtracts the dither amount DL at step 132. The subpath switch 302 selects the output signal MP of the main path 20.

At step 133, the motion amount detecting circuit 50 detects the motion amount MV. At step 134, the level detecting circuit 300 detects the level amount LV. At step 135, the level detecting circuit 300 determines whether the level amount LV is zero.

When it is determined at step 135 that the level amount LV is zero, or when it is determined at step 135 that the level amount LV is not zero and also when it is determined at step 136 that pMV+qLV is smaller than SPsel, the process proceeds to step 139, respectively. The motion amount MV is compared with the predetermined threshold value (i.e., the determination threshold value) TD. On the other hand, when it is determined at step 135 that the level amount LV is not zero and also when it is determined at step 136 that pMV+qLV is equal to or larger than SPsel, the process proceeds to step 137. At step 136, PMV+LV is calculated.

At step 135, the subpath determining circuit 301 determines whether the level amount LV is zero. At step 136, p and q represent coefficients to take balance in the calculation of the motion amount MV and the level amount LV, respectively, and SPsel is a determination threshold value. When pMV+qLV is large, this means that the gray scale has a large motion amount MV and a false contour occurs easily in this gray scale. In this case, the subpath switch 302 selects the output SP of the subpath 10.

At step 137, the dither amount DL is calculated, and the subpath determining circuit 301 outputs the path determination signal PSW of “1”. At step 138, the dither amount DL is added or subtracted, and the subpath switch 302 selects the output signal SP of the subpath 10, and the process returns to step 133. In other words, because the subpath switch 302 selects the subpath at step 138, any selection executed by the dither changeover circuit 203 has no effect. Whether the level amount LV is zero is determined at step 135 for the following reason. When a false contour does not appear in a certain gray scale even when the motion amount MV is very large, it is meaningless to change over the path to the subpath 10. This is because when the path is changed over to the subpath 10 having a smaller number of gray scales, particle noise becomes large and the image quality is degraded. Therefore, when the level amount LV is zero, the output signal SP of the subpath 10 is not selected.

When it is determined at step 139 that the motion amount MV is equal to or larger than the determination threshold value TD, the process proceeds to step 13A. At step 13A, the dither amount DL is calculated, and the subpath determining circuit 301 outputs the path determination signal PSW “0”. The process proceeds to step 13B, and the dither amount DL is added or subtracted. The subpath switch 302 selects the output signal MP of the main path 20, and the process returns to step 133.

On the other hand, when it is determined at step 139 that the motion amount MV is smaller than the determination threshold value TD, the process proceeds to step 13C. At step 13C, the subpath determining circuit 301 sets the dither amount DL=0, and outputs the path determination signal PSW “0”. The process proceeds to step 13D, and the dither amount DL is added or subtracted. The subpath switch 302 selects the output signal MP of the main path 20, and the process returns to step 133.

As explained above, one of the three signals including the output signal SP of the subpath 10, the output signal MPD as a result of executing the dither addition or subtraction in the main path 20, and the output signal MPL as a result of not executing the dither addition or subtraction in the main path 20 is selectively changed over in the pixel unit, based on the motion amount MV, the level amount LV, and the dither coefficient DK. With this arrangement, the position where a false contour occurs is diffused and modulated, and dispersed to the surrounding. Consequently, a false contour can be decreased. Because the position is diffused and modulated based on the motion amount MV, the intensity of the occurrence of a false contour that a person recognizes can be controlled to be stronger when the speed at which the person traces a moving target is faster, that is, when the speed of the moving target is faster. By controlling the intensity of the dither amount according to the moving speed or the motion amount, overmodulation or modulation shortage can be avoided.

FIG. 19 is a block diagram showing still other example of the path (the main path) 20 in the multi-gray-scale image signal processing circuit of the image display apparatus according to a fourth embodiment of the present invention.

As is clear from a comparison between FIG. 19 and FIG. 3 explained above, the arrangement of the error diffusion circuit 201, the dither circuit 202, the dither changeover circuit 203, and the dither changeover determining circuit 204 can be changed. In other words, in the fourth embodiment, the error diffusion circuit 201 that is provided immediately after the gain control circuit 200 in FIG. 3 is provided after the dither changeover circuit 203.

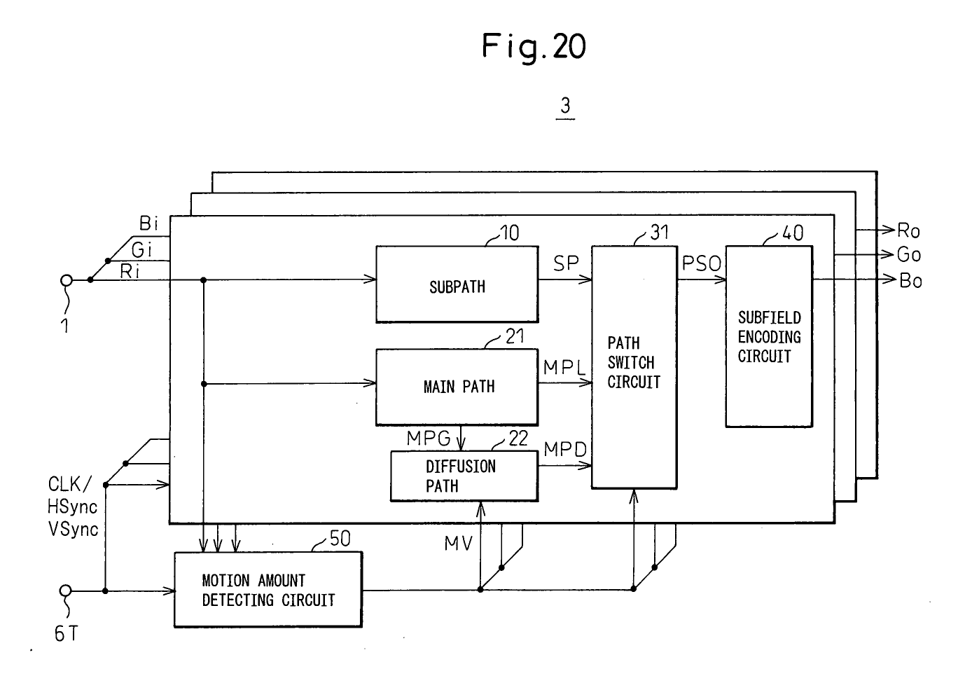

FIG. 20 is a block diagram showing one example of the multi-gray-scale image signal processing circuit 3 of the image display apparatus according to a fifth embodiment of the present invention. In FIG. 20, the reference numeral 10 denotes the subpath, a reference numeral 21 denotes a main path, 22 denotes a diffusion path, 31 denotes a path switch circuit, the reference numeral 40 denotes the subfield encoding circuit, and 50 denotes the motion amount detecting circuit.

As is clear from a comparison between FIG. 20 and FIG. 13 explained above, the multi-gray-scale image signal processing circuit 3 according to the fifth embodiment includes the subpath 10, the main path 21, and the diffusion path 22 for each primary color. The path switch circuit 31 selects one of an output of the subpath 10, an output of the main path 21, and an output of the diffusion path 22, and outputs the selected output signal to the subfield encoding circuit 40. The subpath 10 displays an input image signal at a predetermined gray scale level (for example, a gray scale level smaller than the gray scale level of the input image signal), and the main path 21 can display the input image signal at an actual display gray scale level.

The subpath 10 has a configuration similar to that of the subpath 10 shown in FIG. 13, and outputs the signal SP. The main path 21 receives the input image signal, and outputs a signal MPG to the diffusion path 22, and also outputs a signal MPL to the path switch circuit 31. The motion amount detecting circuit 50 also has a configuration similar to that of the modulation detecting circuit 50 shown in FIG. 13, and outputs the motion amount MV.

The diffusion path 22 receives the output signal MPG of the main path 21 and the output signal (i.e., the motion amount) MV of the motion amount detecting circuit 50, and outputs the signal MPD that is obtained by performing a diffusion process to the output signal MPG according to the motion amount MV. The path switch circuit 31 selects one of the output signal SP of the subpath, the output signal MPL of the main path 21, and the output signal MPD of the diffusion path 22, following the motion amount MV detected by the motion amount detecting circuit 50, and outputs the detected output to the subfield encoding circuit 40 as a signal PSO. The subfield encoding circuit 40 also has a configuration similar to that of the subfield encoding circuit 40 shown in FIG. 13.

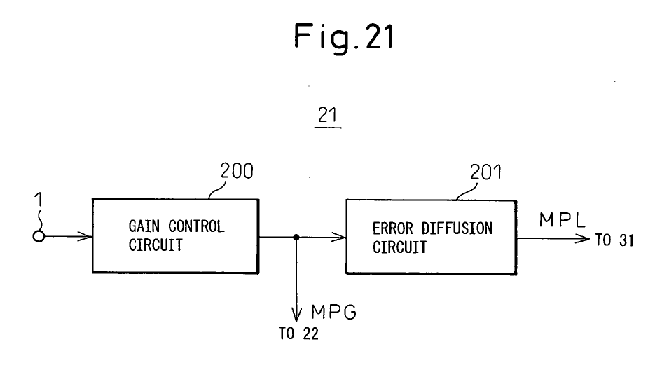

FIG. 21 is a block diagram showing one example of the main path 21 of the multi-gray-scale image signal processing circuit shown in FIG. 20.

As is clear from FIG. 21, the main path 21 includes the gain control circuit 200 and the error diffusion circuit 201. The output signal MPG of the gain control circuit 200 is supplied to the diffusion path 22, and the output signal MPL of the error diffusion circuit 201 is supplied to the path switch circuit 31.

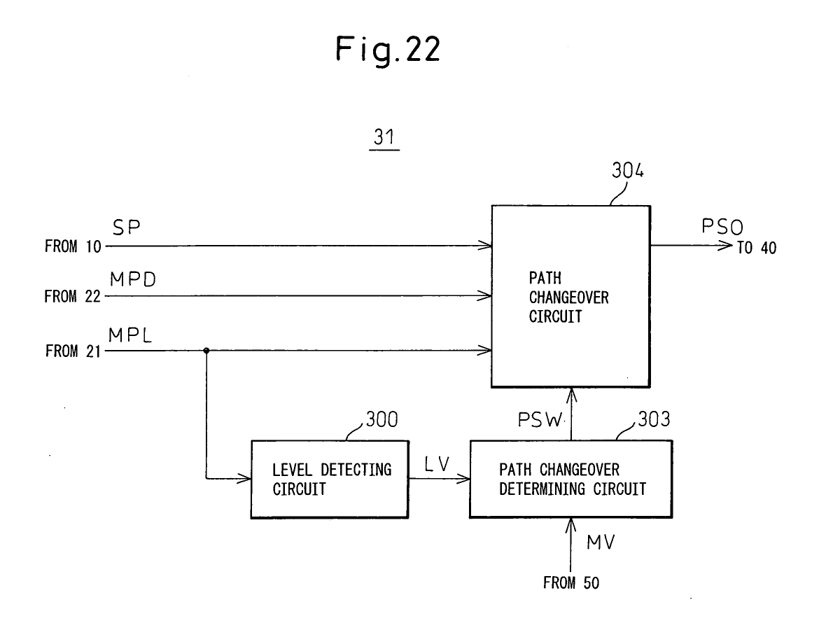

FIG. 22 is a block diagram showing one example of the path switch circuit 31 of the multi-gray-scale image signal processing circuit shown in FIG. 20.

As shown in FIG. 22, the path switch circuit 31 includes the level detecting circuit 300, a path changeover determining circuit 303, and a path changeover circuit 304. The level detecting circuit 300 has a function similar to that of the level detecting circuit 300 shown in FIG. 13. The level detecting circuit 300 outputs the level amount LV to the path changeover determining circuit 303, based on the output signal MPL of the error diffusion circuit 201. The path changeover determining circuit 303 outputs the control signal PSW for the path changeover circuit 304 to change over the path, based on the level amount LV from the level detecting circuit 300 and the motion amount MV from the motion amount detecting circuit 50. The path changeover circuit 304 selects one of the output signal SP of the subpath 10, the output signal MPL of the main path 21, and the output signal MPD of the diffusion path 22, based on the output signal PSW of the path changeover determining circuit 303, and outputs the selected output signal to the subfield encoding circuit 40 as the signal PSO.

In other words, values of the output signals PSW from the path changeover determining circuit 303 are “0”, “1”, and “2”. The path changeover circuit 304 selects the output signal MPL of the main path 21 when the value of PSW is “0”, selects the output signal MPD of the diffusion path 22 when the value of PSW is “1”, and selects the output signal SP of the subpath 10 when the value of PSW is “2”.

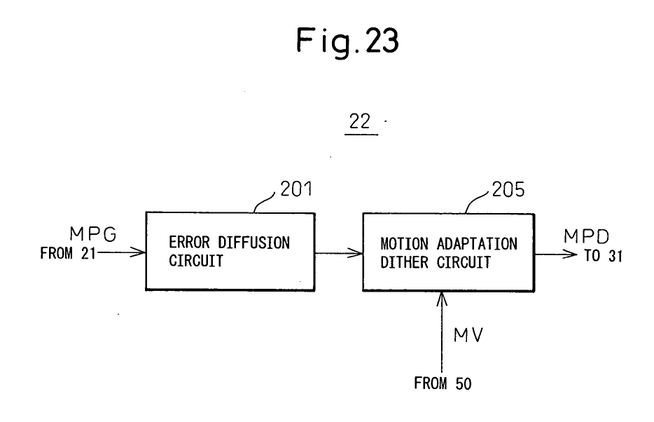

FIG. 23 is a block diagram showing one example of the diffusion path 22 of the multi-gray-scale image signal processing circuit shown in FIG. 20.

As shown in FIG. 23, the diffusion path 22 includes the error diffusion circuit 201, and the motion adaptation dither circuit 205. The error diffusion circuit 201 has a function similar to that of the error diffusion circuit 201 in the main path 21. The motion adaptation dither circuit 205 calculates the dither amount DL based on the motion amount MV as the output of the motion detecting circuit 50, adds or subtracts this dither amount DL to or from the output of the error diffusion circuit 201, and outputs the signal MPD. The motion adaptation dither circuit 205 can be also configured as the dither circuit 202 (for example, see FIG. 3 or FIG. 19).

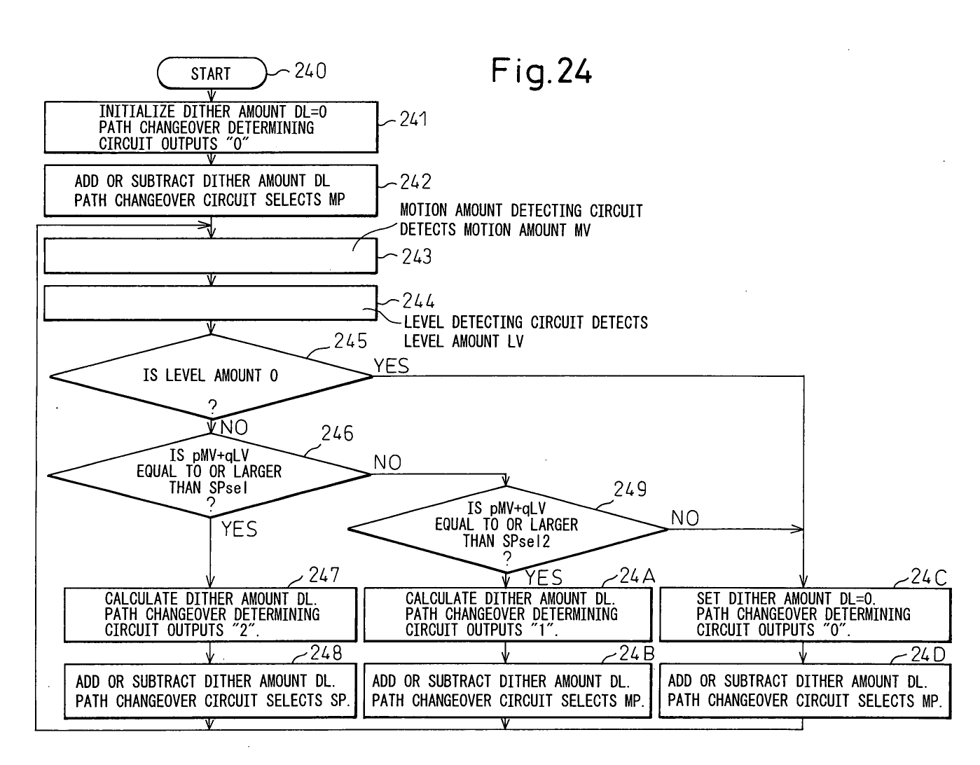

FIG. 24 is a flowchart showing one example of a process in the multi-gray-scale image signal processing circuit of the image display apparatus according to the fifth embodiment of the present invention shown in FIG. 20. The dither coefficient DK to be used can be any one of those explained with reference to FIG. 10A to FIG. 10C, or the dither coefficient shown in FIG. 5. The relationship between the motion amount MV and the calculated motion amount MVC to be applied in this process can be any one of the relationships shown in FIG. 12A to FIG. 12D.

When the process starts at step 240, the process is initialized at step 241, and the dither amount calculating circuit 58 sets the dither amount DL=0, and the path changeover determining circuit 303 outputs the determination signal PSW “0”. At step 242, the dither circuit 53 adds or subtracts the dither amount DL, and the dither changeover circuit 304 selects the output signal MPL of the main path 21.

At step 243, the motion amount detecting circuit 50 detects the motion amount MV. At step 244, the level detecting circuit 300 detects the level amount LV. At step 245, the level detecting circuit 300 determines whether the level amount LV is zero.

When it is determined at step 245 that the level amount LV is zero, the process proceeds to step 24C. When it is determined at step 245 that the level amount LV is not zero and also when it is determined at step 246 that pMV+qLV is not equal to or larger than SPsel, the process proceeds to step 249. When it is determined at step 249 that pMV+qLV is not larger than SPsel2 (i.e., pMV+qLV<SPsel2<SPsel), the process proceeds to step 24C. At step 246, p and q represent coefficients to take balance in the calculation of the motion amount MV and the level amount LV, respectively, and SPsel SPsel2 are determination threshold values. There is a relationship of SPsel>SPsel2 between the determination threshold values SPsel and SPsel2.

Assume that the motion amount MV takes a value from 0 to 15, and the level amount takes a value from 0 to 5 like the conversion data shown in FIG. 5, for example. When p=1 and q=3, a maximum value that pMV can take and a maximum value that qLV can take become the same values. In the path changeover determining circuit 303, the balance of the motion amount and the calculation of the level amount becomes the same. When p=1 and q=2, a value that pMV can take becomes larger than a value that qLV can take. Therefore, the path changeover determining circuit 303 determines the motion amount with priority.

At step 24C, the path changeover determining circuit 303 sets the dither amount DL to zero, and outputs the determination signal PSW “0”. At step 24D, the dither amount DL is added or subtracted, and the path changeover circuit 304 selects the output signal MPL of the main path 21. The process returns to step 243.

When it is determined at step 245 that the level amount LV is not zero and also when it is determined at step 246 that pMV+qLV is equal to or larger than SPsel (i.e., SPsel≦pMV+qLV), the process proceeds to step 247. That pMV+qLV is equal to or larger than SPsel (i.e., SPsel≦pMV+qLV, that is pMV+qLV is large) means that a gray scale has a large motion amount MV and a false contour occurs easily in this gray scale. When the gray scale has a large motion amount MV and a false contour occurs easily in this gray scale, the process proceeds to step 247. At step 247, the dither amount DL is calculated, and the path changeover determining circuit 303 outputs the determination signal PSW “2”. At step 248, the dither amount DL is added or subtracted, and the path changeover circuit 304 selects the output signal SPL of the subpath 10. The process returns to step 243. When the output signal SP of the subpath 10 is selected at step 248, addition of subtraction of the dither amount DL has no influence.

When it is determined at step 245 that the level amount LV is not zero and also when it is determined at step 246 that pMV+qLV is not equal to or larger than SPsel, the process proceeds to step 249. When it is determined at step 249 that pMV+qLV is equal to or larger than SPsel2 (i.e., SPsel2≦pMV+qLV<SPsel), the process proceeds to step 24A. At step 24A, the dither amount DL is calculated, and the path changeover determining circuit 303 outputs the determination signal PSW “1”. At step 24B, the dither amount DL is added or subtracted, and the path changeover circuit 304 selects the output signal MPD of the diffusion path (i.e., the dithering path) 22. The process returns to step 243.

In the above determination of the level amount 0 at step 245, in the case of a gray scale level in which no false contour occurs even when the motion amount is large, it is meaningless to change over the path to the subpath or the dither process path (i.e., when there is little motion, a changeover of the path to the subpath having a smaller number of gray scales causes an increase in particle noise, and a changeover of the path to the dither process path generates an unpleasant dither pattern or degradation of image quality). Therefore, when the level amount is zero, the subpath or the dithering path is not selected. As explained above, in the fifth embodiment, the dither amount DL is determined based on the motion amount MV, and the path is changed over between the main path, the subpath, and the dithering path (i.e., the diffusion path), based on the motion amount MV and the level amount LV.

As explained above with reference to FIG. 20 to FIG. 24, the image display apparatus according to the fifth embodiment performs a level detection, based on the output signal MPL of the error diffusion circuit. On the other hand, the image display apparatus according to the third embodiment shown in FIG. 13 to FIG. 18 performs a level detection, based on the output signal MP that is obtained by executing an error diffusion and further executing a dithering. While a level detection is different depending on the dither amount DL to be added or subtracted, both image display apparatuses can improve image quality of the moving-image display, by dispersing a false contour to the surrounding pixels.

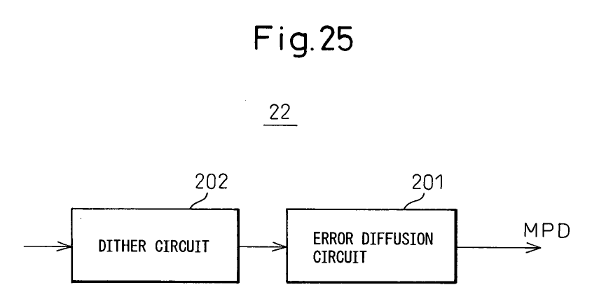

FIG. 25 is a block diagram showing a modification of the diffusion path of the multi-gray-scale image signal processing circuit shown in FIG. 20.

As is clear from a comparison between FIG. 25 and FIG. 21, the diffusion path 22 in this modification includes the dither circuit 202, and the error diffusion circuit 201, and performs error diffusion after dithering. It is needless to mention that the dither circuit 202 is configured as the motion adaptation dither circuit shown in FIG. 23.

When false contours are generated in the surrounding instead of generating false contours at one position in concentration, the false contours is not recognized so strongly. Therefore, when the subpath 10 is inserted into the main path 20 or 21 at every one pixel, the intensity of the false contour becomes weak, although the false contour occurs in a wide area. With this arrangement, the false contour is not recognized easily.

In an image display apparatus having 1,024 dots as a number of horizontal pixels and 42 inches as a screen size, for example, a false contour comes to be recognized when each field moves about four dots to a horizontal direction, and a false contour also comes to be recognized strongly when the moving speed increases, from experience. In other words, when an image is moving slowly, a false contour is little recognized, and is very weak when the false contour is recognized. In this case, when a subpath is inserted according to the path changeover method, particle noise of the subpath is recognized because of a small number of gray scales in the subpath. When a dither coefficient is increased according to the dither method, hatched noise due to the dither is recognized. Therefore, when an image is moving slowly, it is preferable to control such that the dither coefficient according to the dither method is made small and the subpath is not selected.

On the contrary, when an image is moving fast, the particle noise is not recognized easily even when the rate (or frequency) of selecting the subpath is increased by the path changeover method. However, the false contour is recognized more strongly than the false-contour reduction capacity according to the path changeover method. As a result, the false-contour reduction effect becomes weak. Similarly, there is also a limit to the false-contour reduction effect according to the dither method, even when the dither coefficient is increased. Accordingly, when an image is moving fast, a combined use of the dither method and the path changeover method is preferable to improve the false-contour reduction capacity. Consequently, it is preferable to gradually change the dither coefficient according to the dither method and the ratio of inserting a subpath according to the path changeover method, corresponding to the moving speed.

In the above, it is needless to mention that the present invention can be also achieved for the three primary colors of RGB, when a circuit is available for each primary color signal. The application of the present invention is not limited to the plasma display device. Further, the weight of the subfield according to the present invention can be the weight of data or the weight of luminance.

### INDUSTRIAL APPLICABILITY

The present invention can be widely applied to an image display apparatus including a plasma display device. For example, the invention can be applied to an image display apparatus that is used as a display unit of a personal computer and a work station, a flat wall television, and a device that displays advertising and information.

1. An image display apparatus that divides one field into a plurality of weighted subfields and combines the plurality of subfields to perform a multi-gray-scale image display on a display panel, the image display apparatus comprising:
a motion amount detecting circuit that detects a motion amount from a current field and a field before the current field based on an input image signal;
a diffusion amount calculating circuit that calculates a diffusion amount to diffuse false contour noise to the surrounding, based on a gray scale of the input image signal and the detected motion amount; and
a diffusion circuit that performs a diffuse process in a diffusion amount calculated by the diffusion amount calculating circuit.

2. The image display apparatus as claimed in claim 1, further comprising a motion amount fixing circuit that fixes the detected motion amount to a predetermined value when the detected motion amount is equal to or larger than a predetermined threshold value, wherein
the diffusion amount calculating circuit calculates the diffusion amount, based on the fixed motion amount and the gray scale of the input image signal.

3. The image display apparatus as claimed in claim 2, wherein
the predetermined value that fixes the motion amount is larger than the predetermined threshold value.

4. The image display apparatus as claimed in claim 1, wherein
the diffusion amount calculating circuit calculates the diffusion amount from a predetermined proportional coefficient of the motion amount and a diffusion coefficient based on the gray scale of the input image signal.

5. The image display apparatus as claimed in claim 1, wherein
the diffusion amount calculating circuit calculates the diffusion amount from a predetermined proportional coefficient of the motion amount and a diffusion coefficient based on the gray scale of the input image signal when the motion amount is equal to or larger than a predetermined threshold value, and sets the diffusion amount to zero when the motion amount is smaller than the predetermined threshold value.

6. The image display apparatus as claimed in claim 1, wherein
when the motion amount is equal to or larger than a predetermined value, the diffusion amount calculating circuit calculates the diffusion amount from (MV−TD)×m, and a diffusion coefficient based on the gray scale of the input image signal, where MV represents a motion amount, TD represents a predetermined threshold value, and m represents a predetermined proportional coefficient of a motion amount.

7. The image display apparatus as claimed in claim 4, wherein
the diffusion coefficient is constant for all gray scales.

8. The image display apparatus as claimed in claim 4, wherein
the diffusion coefficient is in a proportional relationship with the gray scale of the input image signal.

9. The image display apparatus as claimed in claim 4, wherein
the diffusion coefficient is in a logarithmic relationship with the gray scale of the input image signal.

10. The image display apparatus as claimed in claim 4, wherein
the diffusion coefficient is before a carry.

11. The image display apparatus as claimed in claim 1, wherein
the diffusion circuit performs a diffuse process to only a specific gray scale of the input image signal.

12. The image display apparatus as claimed in claim 1, wherein
the diffusion circuit performs a dithering.

13. An image display apparatus that divides one field into a plurality of weighted subfields and combines the plurality of subfields to perform a multi-gray-scale image display on a display panel, the image display apparatus comprising:
a main path that generates a signal of a predetermined number of gray scales from an input image signal;
a subpath that generates a signal of gray scales of which number is smaller than the number of gray scales in the main path;
a path switch circuit that outputs one of a signal generated in the main path and a signal generated in the subpath, by changing over between the signal generated in the main path and the signal generated in the subpath;
a motion amount detecting circuit that detects an area which moves between a current field and a field before the current field from the input image signal, and that outputs a motion amount as an amount of the move;
a level detecting circuit that detects a level amount of intensity of a false contour of a moving image when the false contour occurs in the main path;
a subpath determining circuit that compares the detected motion amount and the detected level amount with predetermined set values, and determines a gray scale of a moving image area having high intensity of the occurrence of a false contour;
a subpath switch that changes over the path switch circuit from an output of the main path to an output of the subpath, based on a result of a determination of the subpath determining circuit;
a diffusion coefficient generating circuit that generates a diffusion coefficient which depends on a gray scale of the input image signal used to calculate a diffusion amount of false contour noise to be diffused to the surrounding;
a diffusion amount calculating circuit that calculates a diffusion amount based on the motion amount and the diffusion coefficient; and
a diffusion circuit that performs a diffuse process in a diffusion amount calculated by the diffusion amount calculating circuit, wherein
the image display apparatus decreases a false contour by controlling the subpath switch and the diffusion amount.

14. The image display apparatus as claimed in claim 13, further comprising a motion amount fixing circuit that fixes the detected motion amount to a predetermined value when the detected motion amount is equal to or larger than a predetermined threshold value, wherein
the diffusion amount calculating circuit calculates the diffusion amount, based on the fixed motion amount and a diffusion coefficient that depends on the gray scale.

15. The image display apparatus as claimed in claim 14, wherein
the predetermined value that fixes the motion amount is larger than the predetermined threshold value.

16. The image display apparatus as claimed in claim 13, wherein
the diffusion amount calculating circuit calculates the diffusion amount from a predetermined proportional coefficient of the motion amount and a diffusion coefficient based on the gray scale of the input image signal.

17. The image display apparatus as claimed in claim 13, wherein
the diffusion amount calculating circuit calculates the diffusion amount from a predetermined proportional coefficient of the motion amount and a diffusion coefficient based on the gray scale of the input image signal, when the motion amount is equal to or larger than a predetermined threshold value, and sets the diffusion amount to zero, when the motion amount is smaller than the predetermined threshold value.

18. The image display apparatus as claimed in claim 13, wherein
when the motion amount is equal to or larger than a predetermined value, the diffusion amount calculating circuit calculates the diffusion amount from (MV−TD)×m, and a diffusion coefficient based on the gray scale of the input image signal, where MV represents a motion amount, TD represents a predetermined threshold value, and m represents a predetermined proportional coefficient of a motion amount.

19. The image display apparatus as claimed in claim 13, wherein
the diffusion coefficient is constant for all gray scales.

20. The image display apparatus as claimed in claim 13, wherein
the diffusion coefficient is in a proportional relationship with the gray scale of the input image signal.

21. The image display apparatus as claimed in claim 13, wherein
the diffusion coefficient is in a logarithmic relationship with the gray scale of the input image signal.

22. The image display apparatus as claimed in claim 13, wherein
the diffusion coefficient is before a carry.

23. The image display apparatus as claimed in claim 13, wherein
the diffusion circuit performs a diffuse process to only a specific gray scale of the input image signal.

24. The image display apparatus as claimed in claim 13, wherein
the diffusion circuit performs a dithering.

25. The image display apparatus as claimed in claim 13, wherein
the setting of the level amount is after a carry.

26. The image display apparatus as claimed in claim 13, wherein
the subpath determining circuit changes over the main path to the subpath, when a sum of a product of the motion amount and a first value and a product of the level amount and a second value is equal to or larger than a third value.

27. The image display apparatus as claimed in claim 13, wherein
the subpath determining circuit changes over the main path to the subpath, when a sum of a product of the motion amount and a first value and a product of the level amount and a second value is equal to or larger than a third value, and also when the level amount is other than zero.

28. An image display apparatus that divides one field into plural weighted subfields and combines the plural subfields to perform a multi-gray-scale image
display on a display panel, the image display apparatus comprising:
a main path that generates a signal of a predetermined number of gray scales from an input image signal;
a subpath that generates a signal of gray scales of which number is smaller than the number of gray scales in the main path;
a diffusion process path that generates a signal obtained by performing a diffusion process to the input image signal;
a path switch circuit that outputs one of a signal generated in the main path, a signal generated in the subpath, and a signal generated in the diffusion process path, by changing over between the signal generated in the main path, the signal generated in the subpath, and the signal generated in the diffusion process path;
a motion amount detecting circuit that detects an area which moves between a current field and a field before the current field from the input image signal, and that outputs a motion amount as an amount of the move;
a level detecting circuit that detects a level amount of intensity of a false contour of a moving image when the false contour occurs in the main path;
a path changeover determining circuit that compares the detected motion amount and the detected level amount with predetermined set values, and determines a gray scale of a moving area having high intensity of the occurrence of a false contour;
a path changeover circuit that changes over the path switch circuit to any one of an output of the main path, an output of the subpath, and an output of the diffusion process path, based on a result of a determination of the subpath determining circuit;
a diffusion coefficient generating circuit that generates a diffusion coefficient which depends on a gray scale of the input image signal used to calculate a diffusion amount of false contour noise to be diffused to the surrounding;
a diffusion amount calculating circuit that calculates a diffusion amount based on the motion amount and the diffusion coefficient; and
a diffusion circuit that performs a diffuse process in a diffusion amount calculated by the diffusion amount calculating circuit, wherein
the image display apparatus decreases a false contour by controlling the path changeover switch and the diffusion amount.

29. The image display apparatus as claimed in claim 28, wherein
the path changeover determining circuit includes a first set value and a second set value smaller than the first set value, and
when a diffusion value calculated by the diffusion amount calculating circuit is equal to or larger than the first set value, the path changeover determining circuit selects the subpath,
when a diffusion value calculated by the diffusion amount calculating circuit is smaller than the first set value and equal to or larger than the second set value, the path changeover determining circuit selects the diffusion process path, and
when a diffusion value calculated by the diffusion amount calculating circuit is smaller than the second set value, the path changeover determining circuit selects the main path.

30. The image display apparatus as claimed in claim 28, wherein
the diffusion circuit is a dithering circuit.

31. A method of driving an image display apparatus that divides one field into a plurality of weighted subfields and combines the plurality of subfields to perform a multi-gray-scale image display on a display panel, the method comprising:
a motion amount detecting step of detecting a motion amount from a current field and a field before the current field based on an input image signal;
a diffusion amount calculating step of calculating a diffusion amount to diffuse false contour noise to the surrounding, based on a gray scale of the input image signal and the detected motion amount; and
a diffusion step of performing a diffuse process in the calculated diffusion amount.

32. The method of driving an image display apparatus as claimed in claim 31, further comprising a motion amount fixing step of fixing the detected motion amount to a predetermined value when the detected motion amount is equal to or larger than a predetermined threshold value, wherein
at the diffusion amount calculating step, the diffusion amount is calculated based on the fixed motion amount and the gray scale of the input image signal.

33. The method of driving an image display apparatus as claimed in claim 32, wherein
the predetermined value that fixes the motion amount is larger than the predetermined threshold value.

34. The method of driving an image display apparatus as claimed in claim 31, wherein
at the diffusion amount calculating step, the diffusion amount is calculated from a predetermined proportional coefficient of the motion amount and a diffusion coefficient based on the gray scale of the input image signal.

35. The method of driving an image display apparatus as claimed in claim 31, wherein
at the diffusion amount calculating step, when the motion amount is equal to or larger than a predetermined threshold value, the diffusion amount is calculated from a predetermined proportional coefficient of the motion amount and a diffusion coefficient based on the gray scale of the input image signal, and when the motion amount is smaller than the predetermined threshold value, the diffusion amount is set to zero.

36. The method of driving an image display apparatus as claimed in claim 31, wherein
at the diffusion amount calculating step, when the motion amount is equal to or larger than a predetermined value, the diffusion amount is calculated from (MV−TD)×m and from a diffusion coefficient based on the gray scale of the input image signal, where MV represents a motion amount, TD represents a predetermined threshold value, and m represents a predetermined proportional coefficient of a motion amount.

37. The method of driving an image display apparatus as claimed in claim 34, wherein
the diffusion coefficient is constant for all gray scales.

38. The method of driving an image display apparatus as claimed in claim 34, wherein
the diffusion coefficient is in a proportional relationship with the gray scale of the input image signal.

39. The method of driving an image display apparatus as claimed in claim 34, wherein
the diffusion coefficient is in a logarithmic relationship with the gray scale of the input image signal.

40. The method of driving an image display apparatus as claimed in claim 34, wherein
the diffusion coefficient is before a carry.

41. The method of driving an image display apparatus as claimed in claim 31, wherein
at the diffusion step, a diffuse process is performed to only a specific gray scale of the input image signal.

42. The method of driving an image display apparatus as claimed in claim 31, wherein
at the diffusion circuit, a dithering is performed.

43. A method of driving an image display apparatus that divides one field into a plurality of weighted subfields and combines the plurality of subfields to perform a multi-gray-scale image display on a display panel, the method comprising:
a path switching step of outputting one of a signal generated by a main path that generates a signal of a predetermined number of gray scales from an input image signal, and a signal generated by a subpath that generates a signal of gray scales of which number is smaller than the number of gray scales in the main path, by switching between the signal generated in the main path and the signal generated in the subpath;
a motion amount detecting step of detecting an area which moves between a current field and a field before the current field from the input image signal, and outputting a motion amount as an amount of the move;
a level detecting step of detecting a level amount of intensity of a false contour of a moving image when the false contour occurs in the main path;
a subpath determination step of comparing the detected motion amount and the detected level amount with predetermined set values, and determining a gray scale of a moving image area having high intensity of the occurrence of a false contour;
a subpath switching step of switching the path switching step from an output of the main path to an output of the subpath based on a result of a determination at the subpath determination step;
a diffusion coefficient generating step of generating a diffusion coefficient which depends on a gray scale of the input image signal used to calculate a diffusion amount of false contour noise to be diffused to the surrounding;
a diffusion amount calculating step of calculating a diffusion amount based on the motion amount and the diffusion coefficient; and
a diffusion step of performing a diffuse process in the calculated diffusion amount, wherein
a false contour is decreased by controlling the subpath switch and the diffusion amount.

44. The method of driving an image display apparatus as claimed in claim 43, further comprising a motion amount fixing step of fixing the detected motion amount to a predetermined value when the detected motion amount is equal to or larger than a predetermined threshold value, wherein
at the diffusion amount calculating step, the diffusion amount is calculated based on the fixed motion amount and a diffusion coefficient that depends on the gray scale.

45. The method of driving an image display apparatus as claimed in claim 44, wherein
the predetermined value that fixes the motion amount is larger than the predetermined threshold value.

46. The method of driving an image display apparatus as claimed in claim 43, wherein
at the diffusion amount calculating step, the diffusion amount is calculated from a predetermined proportional coefficient of the motion amount and a diffusion coefficient based on the gray scale of the input image signal.

47. The method of driving an image display apparatus as claimed in claim 43, wherein
at the diffusion amount calculating step, when the motion amount is equal to or larger than a predetermined threshold value, the diffusion amount is calculated from a predetermined proportional coefficient of the motion amount and a diffusion coefficient based on the gray scale of the input image signal, and when the motion amount is smaller than the predetermined threshold value, the diffusion amount is set to zero.

48. The method of driving an image display apparatus as claimed in claim 43, wherein
at the diffusion amount calculating step, when the motion amount is equal to or larger than a predetermined value, the diffusion amount is calculated from (MV−TD)×m, and from a diffusion coefficient based on the gray scale of the input image signal, where MV represents a motion amount, TD represents a predetermined threshold value, and m represents a predetermined proportional coefficient of a motion amount.

49. The method of driving an image display apparatus as claimed in claim 43, wherein
the diffusion coefficient is constant for all gray scales.

50. The method of driving an image display apparatus as claimed in claim 43, wherein
the diffusion coefficient is in a proportional relationship with the gray scale of the input image signal.

51. The method of driving an image display apparatus as claimed in claim 43, wherein
the diffusion coefficient is in a logarithmic relationship with the gray scale of the input image signal.

52. The method of driving an image display apparatus as claimed in claim 43, wherein
the diffusion coefficient is before a carry.

53. The method of driving an image display apparatus as claimed in claim 43, wherein
at the diffusion step, a diffuse process is performed to only a specific gray scale of the input image signal.

54. The method of driving an image display apparatus as claimed in claim 43, wherein
at the diffusion step, a dithering is performed.

55. The method of driving an image display apparatus as claimed in claim 43, wherein
the setting of the level amount is after a carry.

56. The method of driving an image display apparatus as claimed in claim 43, wherein
at the subpath determining step, the main path is changed over to the subpath when a sum of a product of the motion amount and a first value and a product of the level amount and a second value is equal to or larger than a third value.

57. The method of driving an image display apparatus as claimed in claim 43, wherein
at the subpath determining step, the main path is changed over to the subpath, when a sum of a product of the motion amount and a first value and a product of the level amount and a second value is equal to or larger than a third value and also when the level amount is other than zero.

58. A method of driving an image display apparatus that divides one field into a plurality of weighted subfields and combines the plurality of subfields to perform a multi-gray-scale image display on a display panel, the method comprising:
a path switching step of outputting one of a signal generated by a main path that generates a signal of a predetermined number of gray scales from an input image signal, a signal generated by a subpath that generates a signal of gray scales of which number is smaller than the number of gray scales in the main path, and a signal generated from a diffusion process path that generates a signal obtained by performing a diffusion process to the input image signal, by switching between the signal generated in the main path, the signal generated in the subpath, and the signal generated by the diffusion process path;
a motion amount detecting step of detecting an area which moves between a current field and a field before the current field from the input image signal, and outputting a motion amount as an amount of the move;
a level detecting step of detecting a level amount of intensity of a false contour of a moving image when the false contour occurs in the main path;
a path changeover determination step of comparing the detected motion amount and the detected level amount with predetermined set values, and determining a gray scale of a moving image area having high intensity of the occurrence of a false contour;
a path changeover step of changing over the path switching step from an output of the main path to an output of the subpath or an output of the diffusion process path based on a result of a determination at the pass changeover determination step;
a diffusion coefficient generating step of generating a diffusion coefficient which depends on a gray scale of the input image signal used to calculate a diffusion amount of false contour noise to be diffused to the surrounding;
a diffusion amount calculating step of calculating a diffusion amount based on the motion amount and the diffusion coefficient; and
a diffusion step of performing a diffuse process in a diffusion amount calculated at the diffusion amount calculating step, wherein
a false contour is decreased by controlling the path changeover step and the diffusion amount.

59. The method of driving an image display apparatus as claimed in claim 58, wherein
the path changeover determining step includes a first set value and a second set value smaller than the first set value, and
when a diffusion value calculated at the diffusion amount calculating step is equal to or larger than the first set value, the subpath is selected at the path changeover determining step,
when a diffusion value calculated at the diffusion amount calculating step is smaller than the first set value and equal to or larger than the second set value, the diffusion process path is selected at the path changeover determining step, and
when a diffusion value calculated by the diffusion amount calculating step is smaller than the second set value, the main path is selected at the path changeover determining step.

60. The method of driving an image display apparatus as claimed in claim 58, wherein
the diffusion step is a dithering step.
